(19) United States
(12) Patent Application Publication
(10) Pub. No.: US 2013/0289927 A1
(43) Pub. Date: Oct. 31, 2013

(54) ENVIRONMENTAL MONITORING

(71) Applicant: MAGPIE SENSING LLC, Baltimore, MD (US)

(72) Inventors: Thomas Smith, Baltimore, MD (US); Robert Douglas, Baltimore, MD (US); Brendan Ebers, Baltimore, MD (US); Jonathan Smalletz, Baltimore, MD (US); Sinan Ozdemir, Baltimore, MD (US)

(73) Assignee: Magpie Sensing LLC, Baltimore, MD (US)

(21) Appl. No.: 13/871,888

(22) Filed: Apr. 26, 2013

Related U.S. Application Data
(60) Provisional application No. 61/639,698, filed on Apr. 27, 2012.
(60) Provisional application No. 61/691,451, filed on Aug. 21, 2012.

(51) Int. Cl. G06F 17/18

(52) U.S. Cl. CPC G06F 17/18
USPC 702/130; 702/181

(57) ABSTRACT

A computer-based method includes collecting a sequence of measurements related to a controllable environmental parameter in a monitored space over time, deriving a master curve based on the sequence of collected measurements to characterize normal periodic variations in the controllable environmental parameter over time, collecting one or more subsequent measurements that represent the controllable environmental parameter of the monitored space, and evaluating a likelihood that the controllable environmental parameter will, at some future point in time, exceed an acceptable level by comparing a curve associated with one or more of the subsequent measurements to the master curve.

### CROSS-REFERENCE TO RELATED APPLICATIONS

This application claims the benefit of U.S. Provisional Patent Application No. 61/691,451, filed Aug. 21, 2012, entitled System and Method for Monitoring a Physical Environment and U.S. Provisional Patent Application No. 61/639,698, filed Apr. 27, 2012, entitled System and Method for Monitoring a Location, Environment or Object. The contents of the prior applications are incorporated by reference herein.

### BACKGROUND

This specification relates to a system and method of monitoring various conditions associated with a discreet location, environment, or object. More specifically, the specification relates to the monitoring, transmitting, and analysis of location, time, and/or environmental conditions of fixed objects and objects in motion.

### SUMMARY OF THE INVENTION

Maintaining cold chain integrity is increasingly vital for researchers, clinicians, and healthcare product manufacturers. A 2012 study by the Centers for Disease Control and Prevention looked at handling of cold chain vaccines by forty five healthcare providers around the United States. Three quarters of the providers experienced serious cold chain violations during the two-week study period.

Gathering information about cold storage units in real time allows researchers, doctors, and product manufacturers to ensure that these kinds of violations do not damage their products or reduce product efficacy.

For products in transit, gathering location-tagged environmental data can also assist with audits when a biological product or vaccine has spoiled, and a chain of custody needs to be identified to assign liability. Pharmaceutical supply chains can involve up to 14 parties, making chain-of-custody monitoring all the more essential. Location monitoring can be used to combat drug counterfeiting and shipment theft as well.

Often, however, simple data gathering is not enough. Ensuring cold chain integrity requires using rich analytics algorithms to turn raw data into actionable recommendations and warnings which can improve cold storage processes, guide business decisions, and prevent cold chain failures before they occur. Prior approaches to managing cold chain integrity have not provided needed, monitoring, predictive algorithms, and reporting.

In one aspect, a computer-based method includes collecting a sequence of measurements related to a controllable environmental parameter in a monitored space over time, deriving a master curve based on the sequence of collected measurements to characterize normal periodic variations in the controllable environmental parameter over time, collecting one or more subsequent measurements that represent the controllable environmental parameter of the monitored space, and evaluating a likelihood that the controllable environmental parameter will, at some future point in time, exceed an acceptable level by comparing a curve associated with one or more of the subsequent measurements to the master curve.

The phrase “exceeding an acceptable level,” and the like, should be understood to include moving outside of an acceptable range of values for the controllable environmental parameter. This movement can be in either a positive or negative direction. Therefore, a controllable environmental parameter may “exceed an acceptable level” by increasing to a level above an acceptable range of values or, alternatively, by decreasing to a level below an acceptable range of values. For example, the acceptable level may be exceeded if the boundary of an acceptable range is 4° C. and the temperature (i.e., the controllable environmental parameter) reaches 5° C. Likewise, the acceptable level may be exceeded if the boundary of an acceptable range is 0° C., and the temperature (i.e., the controllable environmental parameter) reaches −1° C.

This specification also describes technologies relating to the monitoring of discreet locations, environments, microenvironments, open spaces, enclosed spaces, and fixed objects and objects or items in transit.

In a typical implementation, a computer-based server (including a processor) collects the sequence of measurements related to the controllable environmental parameter in the monitored space over time. Typically, the measurements are collected from an electronic temperature sensor that includes a transmitter configured to send the measurements to the computer-based server. The controllable environmental parameter is controllable by virtue of a system (e.g., a refrigeration system) configured to control the environmental parameter in the monitored space (e.g., a refrigerated container). Typically, the processor derives the master curve based on the sequence of collected measurements to characterize normal periodic variations in the controllable environmental parameter over time. The computer-based server typically collects the one or more subsequent measurements that represent the controllable environmental parameter of the monitored space and evaluates the likelihood that the controllable environmental parameter will, at some future point in time, exceed an acceptable level by comparing a curve associated with one or more of the subsequent measurements to the master curve. The various processing steps can be distributed among multiple processors and/or servers.

Various implementations of the subject matter described herein provide one or more of (or a suite of) cold chain monitoring and analysis technologies for the healthcare industry, food storage industry and other industry sectors concerned with monitoring various environmental conditions. Some exemplary embodiments comprise a shippable, wireless temperature and humidity monitor that provides real-time, location-aware tracking of cold chain products during shipment. This real-time monitoring device, for example, can safeguard products from their arrival at a lab or clinic until the moment of use. Rich analytics algorithms leverage data from the monitoring devices to improve cold chain processes and predict cold storage problems before they occur.

In general, another aspect of the subject matter described in this specification can be embodied in methods that include the actions of receiving SMS compatible data from a remote monitoring device via a cellular network; unencoding the SMS compatible data; storing the unencoded data in a database; retrieving the data via a computer network for display to a user; determining the time, location and or environmental condition of the monitoring device; and alerting a user if the time, location, and or environmental condition is at, above, or below a predetermined parameter. Other embodiments of this aspect include corresponding systems, apparatus, and computer programs, configured to perform the actions of the methods, encoded on computer storage devices.

Another aspect of the subject matter described in this specification can be embodied in methods that include the actions of monitoring one or more environmental conditions at the one or more discreet locations; converting data received from one or more sensor modules to an SMS compatible format; and transmitting the SMS compatible data over a cellular network.

A further aspect of the subject matter described in this specification can be embodied in a device comprising a circuit board comprising; a power source and power regulation systems; a microprocessor; a persistent memory device; a cellular transceiver; one or more sensor modules in communication with the microprocessor; and a housing at least partially encasing the circuit board and the one or more sensor units.

These and other embodiments can each optionally include one or more of the following features. The sensor module is removable. The sensor module is part of a modular system for customizing conditions to monitor. The sensor module monitors environmental conditions including temperature, humidity, barometric pressure, moisture, visible or ultraviolet light intensity, radiation, particulate contamination, air quality, relative position, altitude, time, acceleration, and shock load.

Particular embodiments of the subject matter described in this specification can be implemented so as to realize one or more of the following advantages: modularization and customization of monitored conditions based on desired sensitivities; monitor and tracking of the environment of goods in transit by ensuring that the environment of the goods always corresponds to the environment of the monitoring device; direct transmission to a web server of monitored environmental conditions using SMS messaging instead of data connections; passive collection of cellular network information and derivation of device locations and time at the server side thereby avoiding data processing at the device; use of low cost cellular infrastructure, unique identification of each monitoring device using SIM data or cellular telephone number.

Other implementations of the present invention may comprise a means for determining the properties of an environmental control system using empirical data, optimizing that system for control of a particular environment, and forecasting system breakdown or system states which may result in the controlled environment's conditions deviating from specific bounds.

Further implementations may also include an algorithm for determining or fitting an ideal line, curve or other mathematical function to data gathered from a regulated environment, a process for determining the properties of the environmental control system regulating that environment based on the ideal line, curve or function, a process for suggesting changes to the properties of that system so as to improve its ability to regulate the environment, an algorithm for detecting whether the environment's conditions are deviating from a desired state, and a process for forecasting the effect and time course of any detected deviations.

Still further implementations of the present invention apply a range of analytical techniques to derive useful information from data captured by various monitoring devices. This includes descriptive, predictive, and prescriptive analytic tiers that each help solve business problems.

For example, an implementation of the invention comprising descriptive analytics derives properties of the cold storage system being monitored. These may include the set point of the system's thermostat, the typical range of temperature values in the system, the duty cycle of the system's compressor, etc. This information informs the user as to whether their storage unit is properly configured to store a particular product.

Laboratories and clinics often use simple consumer refrigerators, even to store sensitive cold chain products. Many consumer refrigerators have thermostats with only basic High and Low settings, or numerical settings which don't correspond directly to a particular temperature. This makes it challenging to determine what temperature a simple refrigerator's thermostat is set to. Using only incoming data from a monitoring device of the present invention, implementations of the algorithms described herein can determine the set point of a refrigerator's thermostat. This allows users to set thermostats precisely, even on simple consumer refrigerators.

In another example, an implementation of the invention comprising predictive analytics detects cold chain problems before temperature bounds are violated. These problems can include three general categories:

(1) Poor Equipment Configuration

Using implementations of the descriptive analytics systems, embodiments of the present invention can determine the basic properties of a cold storage system. If the system is configured incorrectly for the products stored, predictive analytics algorithms spot these configuration problems and alert the system's users. If a clinic must store a vaccine above freezing, for example, and their cold storage unit's average temperature is 2 degrees with a range of 4 degrees, the Magpie system alerts the clinic that their system will drop below freezing each time the compressor cycles on.

(2) Human Error

Simple human error leads to many cold chain violations. In a hectic lab or clinic, doctors and researchers often fail to consistently shut refrigerator or freezer doors, or to ensure that a good seal is established when a door is shut. Overfull or aging storage systems compound this problem. From temperature trend data alone, the embodiments of the present invention determine when a cold storage system door has been left open, alerting the system's users via a web interface, text message or audible alert before temperature bounds are violated.

(3) Equipment Failure

Compressor breakdown and power failure are all-too-common causes of cold chain violations. Even small clinics may hold $50,000 to $70,000 worth of product in their cold storage systems, and many biological samples used in research are irreplaceable. If a cold storage system fails, these sensitive materials can be destroyed. A compressor failure can be particularly devastating if it occurs at night or on a holiday.

Predictive analytics systems of the present invention detect compressor or power failure, alerting users via text message or an automated phone call before bounds are violated. The system can even calculate the estimated time before the cold storage system reaches an unsafe temperature. This gives the user time to pack the failed cold storage system with dry ice, restore power, or take another action to prevent product spoilage.

In addition to predicting cold chain violations before they occur, embodiments of the analytics systems of the present invention provide prescriptive recommendations to improve cold storage processes and business decisions during normal operation.

When configuring refrigeration equipment, for example, users often struggle with determining the correct thermostat setting. A higher setting reduces the risk of products freezing, but a lower setting provides a larger “margin of error” should a failure occur, since products stored at a lower temperature will take longer to spoil if cooling is lost. Prescriptive analytics help users “dial in” the optimal thermostat setting for a particular product, helping to achieve the right balance between freezing risk and spoilage risk.

Embodiments of the prescriptive analytics systems also derive useful meta-information about a cold storage system, including the times of day that are busiest and the periods where the system's door is opened the most. This can guide staff training and institutional policies, ensuring that particular systems are not overused, or that system use is more evenly distributed over a working day.

Using prescriptive analytics, monitoring systems of the present invention can further be used to guide equipment purchase decisions, or to optimally distribute products between a variety of existing cold storage systems. Which refrigerator takes the longest time to cool down? Which is the most stable and should be used to store the most sensitive items? Which brand of cold storage system has the most desirable properties for a particular application? Embodiments of the prescriptive systems of the present invention assist in answering these questions.

As such, advantages of the one or more embodiments of the present invention include: saving time and money by avoiding product spoilage; saving lives by preventing healthcare workers from administering damaged products to patients; ensuring compliance with state and federal safety regulations, saving time through automatic data gathering and reporting; and making better equipment purchasing decisions and develop better cold storage processes.

The phrase “controllable environmental parameter” or the like is used herein. In general, this phrase usually refers to any environment, such as the inside of a refrigerated container, whose environment can somehow be controlled, whether the actual control mechanism (e.g., a refrigeration system in the case of a refrigerated container) is actually functioning properly or not.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an exemplary computer system configured to implement or facilitate one or more of the techniques disclosed herein.

FIG. 2 is a perspective view of an exemplary monitoring device (sensor).

FIG. 3 is a schematic diagram of an exemplary computer server configured to perform various processing and related functionalities disclosed herein.

FIG. 4 is a flowchart showing an exemplary method that can be implemented by the system of FIG. 1.

FIG. 5 is an exemplary screenshot showing system information, including a system alert, to a system operator.

FIG. 6 is a flowchart showing an alternative exemplary method that can be implemented by the system of FIG. 1.

FIGS. 7A-7D are flowcharts that show how an exemplary system might be set up and used.

### DETAILED DESCRIPTION

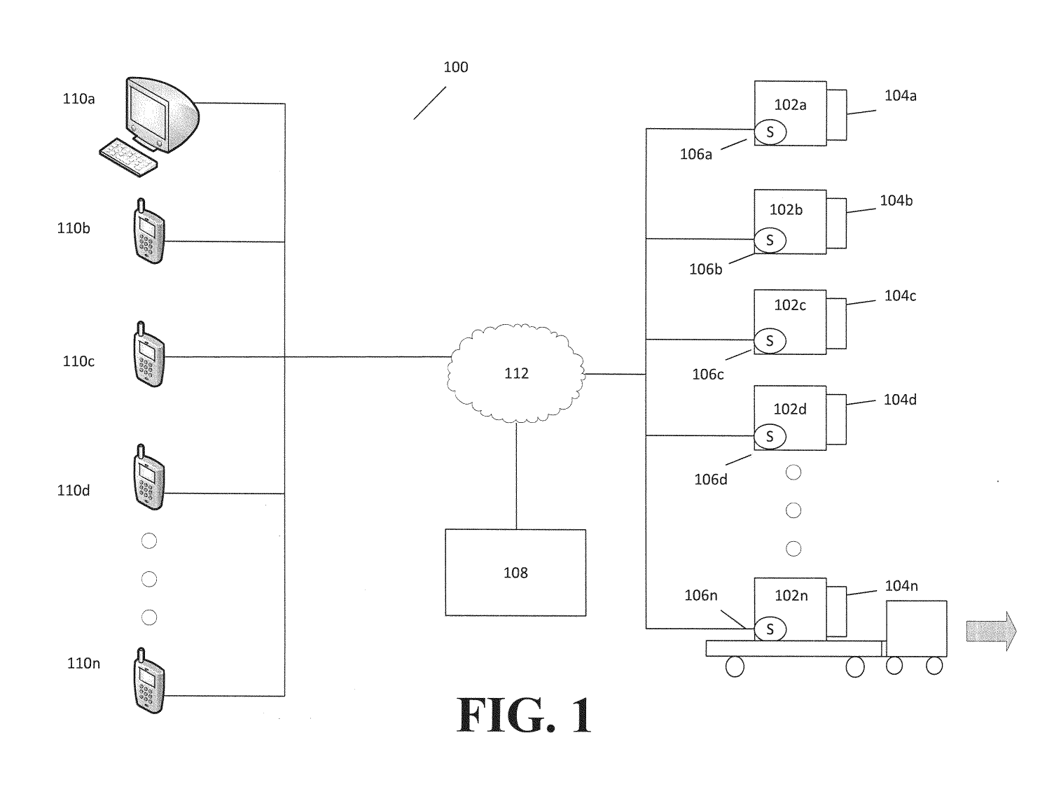

FIG. 1 is a schematic diagram of an exemplary computer-based system 100 configured to monitor one or more environmental parameters associated with multiple different refrigerated storage containers 102a-102n.

In the illustrated example, refrigerated containers 102a-102n are stationary (e.g., in fixed locations at one or more storage facilities) whereas container 102n is movable (i.e., mounted on the back of a flatbed truck). Each container 102a-102n has an associated cooling system 104a-104n that is operable to cool an interior space of the associated container. The cooling systems 104a-104n can be virtually any kind of cooling system such as a portable refrigeration system configured to be directly mounted directly to a container. The cooling systems typically have one or more controllers that have adjustable settings that enable a user to specify one or more operational parameters associated with the cooling system 104a-104n.

The system 100 has a plurality of sensors 106a-106n, with one sensor thermally coupled to the environmentally-controlled interior space of each container 102a-102n. The sensors 106a-106n can be configured to sense any one or more of a variety of different environmental parameters. However, in the illustrated example, the sensors are positioned and generally operable to sense temperature at least periodically in the interior spaces of their corresponding refrigerated containers.

The system 100 has a central server 108. The central server 108 can include any type of device that is generally operable to facilitate or perform one or more of the system functionalities disclosed herein. In a typical implementation, the central server 108 has one or more computer-based processing units and computer-based memory units.

The system 100 also has a plurality of computer-based user interface devices 110a-110n. In general, the user interface devices 110a-110n enable a human user to receive messages from and, in some instances, send data to the central server 108 and/or from one or more of the other system components shown in FIG. 1. In various implementations, the user-interface devices may be smart phones, cell phones, lap top computers, desktop computers, etc.

In the illustrated system 100, the sensors 106a-106n, the central server 108 and the user interface devices 110a-110n are coupled to each other and able to communicate with one another over a computer-based communications network 112 (e.g., the Internet).

As described in further detail herein, the illustrated system 100 is generally operable to collect, using one or more of the sensors 106a-106n, a sequence of measurements related to a controllable environmental parameter (e.g., temperature) in one or more of the refrigerated containers 102a-102n over time. For each container (e.g., 102a), the system 100 derives a master curve based on the sequence of collected measurements from that container 102a to characterize normal periodic variations in the controllable environmental parameter (e.g., temperature) over time. Then, the system collects one or more subsequent measurements that represent the controllable environmental parameter (e.g., temperature) of the container 102a and evaluates the likelihood that the controllable environmental parameter (e.g., temperature) will, at some future point in time, exceed an acceptable level. It does this by essentially comparing a curve associated with one or more of the subsequent measurements to the derived master curve.

Thus, in a typical implementation, the system 100 is operable to provide a prediction as to the likelihood that one or more of the refrigerated containers will, at some point in the future, experience an unacceptably high temperature. The system 100, therefore, is able to alert one or more refrigeration system operators (e.g., one or more humans charged with making sure that the products in one or more of the refrigerated containers remains refrigerated) of potential problems in a timely manner so that appropriate corrective action can be taken. In fact, in a typical system, the predictive nature of the evaluation enables the system to alert an operator to a problem well in advance of the refrigerated product risking damage.

In some implementations, the system 100 is able to identify, by comparing new temperature information to the master curve, the type of problem that the refrigerated container may be experiencing, which the system 100 has determined will lead to an unacceptable condition for the products contained therein. For example, the temperature in a refrigerated container tends to increase much more rapidly if the door to the container has been left open than if the compressor has stopped operating. Therefore, in some instances, the system 100 may consider the rate of change in temperature associated with a potentially problematic situation. In those instances, the system 100 might include with its alert to the operator, for example, that the problem (i.e., a too high temperature at some future point in time) is likely resulting from either a door having been left open or a compressor failure. With this information, the human operator would be in a good position to take proactive, meaningful steps in avoiding the problem predicted and identified by the system 100.

Moreover, in some instances, the system 100 considers the rate of change of a monitored temperature and predicts, based in part on the rate of change, an amount of time before the space inside the corresponding refrigerated container will reach a critical level. The system 100, in some instances, provides the human operator with this information as well.

In addition, the system 100, in some instances, can derive, based on a master curve, one or more physical or operational parameters of the refrigerated container or its associated control system. Based on this information, the system 100 can, in some instances, provide recommendations to the system operator based on the derived parameters. So if, for example, the system 100 determines, based on the master curve, that the actual temperature inside one of the refrigerated containers is swinging (e.g., due to the compressor cycling on and off) outside of a recommended range of temperatures for the product being stored in the container, then the system 100 may provide a recommendation to the operator of that refrigerated container to change its settings.

Typically, the system 100 shares various recommendations and/or information with human operators by making information accessible to those operators (e.g., via text messaging, emailing, website updates, etc.) from their respective user interface devices 110a-110n.

The illustrated system 100 is easy to install, maintain and troubleshoot. It is relatively inexpensive and enables human operators to develop a deeper understanding of the refrigerated containers they are operating and to leverage information about those containers to prevent problems before they occur.

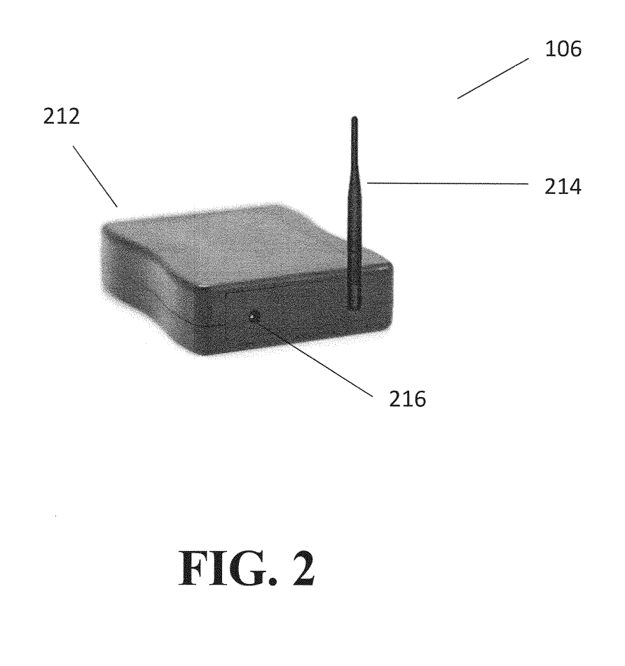

FIG. 2 is a perspective view of a simple exemplary sensor 106 that may be used, for example, in the system 100 of FIG. 1. The illustrated sensor 106 is configured to sense ambient temperature (i.e., to sense temperature of the air surrounding the device) and to transmit data about the sensed temperature to a remote location, wirelessly. The sensor 106 has a housing 212, an antenna 214 and an electrical power connection 216, for attaching a plug. In various implementations, the sensor 106 may sense and/or transmit data continuously, substantially continuously, periodically, or in response to a prompt of some sort.

The illustrated sensor 106 is only one example of a sensor that can be used in the system 100 of FIG. 1. The sensors 106 in FIG. 1 can be any type of sensor, configured to sense any type of environmental parameter and to transmit data wirelessly or over a hard-wired connection. It may include other functionalities, such as processing, memory storage, etc. as well. In addition, different containers may include different types of sensors and some containers may include multiple sensors. In a typical implementation, the sensor 106 shown would be placed inside the environment to be monitored (e.g., inside one of the refrigerated containers of FIG. 1)

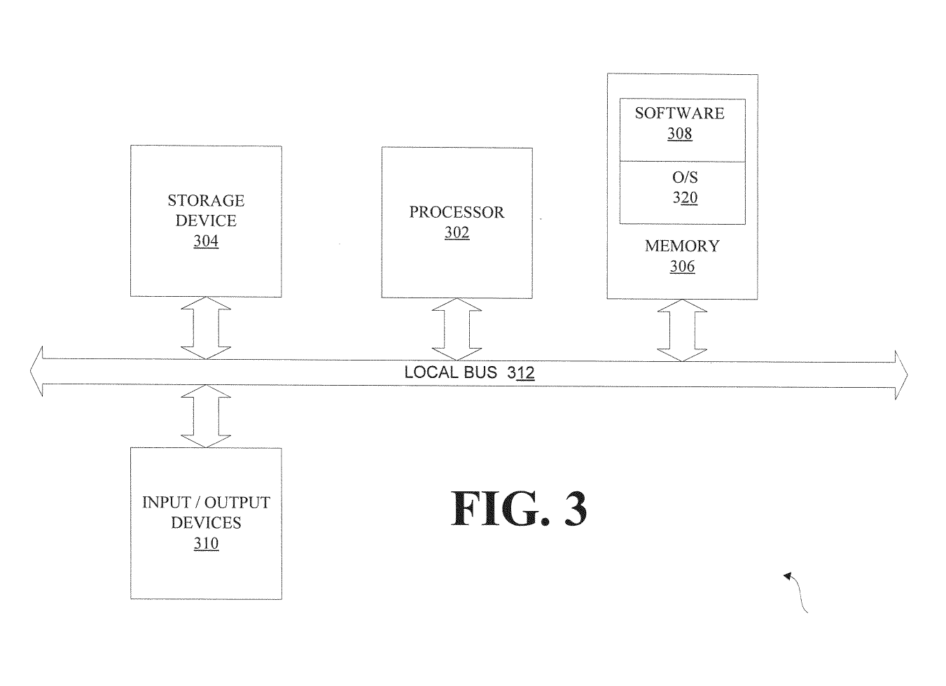

FIG. 3 is a schematic diagram illustrating an example of the server 108 from FIG. 1. In general, the server 108 is configured to execute and/or facilitate one or more of the system functionalities described herein.

The illustrated server 108 has a processor 302, a storage device 304, a memory 306 having software 308 stored therein that, when executed by the processor, causes the processor to perform or facilitate one or more of the functionalities described herein, input and output (I/O) devices 310 (or peripherals), and a local bus, or local interface 312 allowing for communication within the server 108. The local interface 312 can be, for example, one or more buses or other wired or wireless connections. The server 108 may have additional elements, which are omitted for simplicity, such as controllers, buffers caches), drivers, repeaters, and receivers, to facilitate communications and other functionalities. Further, the local interface 312 may include address, control, and/or data connections to enable appropriate communications among the illustrated components.

The processor 302 is a hardware device for executing software, particularly that stored in the memory 306. The processor 302 can be any custom made or commercially available single core or multi-core processor, a central processing unit (CPU), an auxiliary processor among several processors associated with the present server 108, a semiconductor based microprocessor (in the form of a microchip or chip set), a macroprocessor, or generally any device for executing software instructions.

The memory 306 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 306 may incorporate electronic, magnetic, optical, and/or other types of storage media. The memory 306 can have a distributed architecture, where various components are situated remotely from one another, but can be accessed by the processor 302.

The software 308 defines various aspects of the server functionality. The software 308 in the memory 306 may include one or more separate programs, each of which contains an ordered listing of executable instructions for implementing logical functions of the server 108, as described below. The memory 306 may contain an operating system (WS) 520. The operating system essentially controls the execution of programs within the server 108 and provides scheduling, input-output control, file and data management, memory management, and communication control and related services.

The I/O devices 310 may include one or more of any type of input or output device(s). Examples include a keyboard, mouse, scanner, microphone, printer, display, etc. The I/O devices 310 may include one or more devices that communicate via both inputs and outputs, for instance a modulator/demodulator (modem; for accessing another device, system, or network), a radio frequency (RF) or other transceiver, a telephonic interface, a bridge, a router, or other device.

When the server 108 is in operation, the processor 302 executes the software 308 stored within the memory 306, communicates data to and from the memory 306, and generally controls operations of the server 108 pursuant to the software 308.

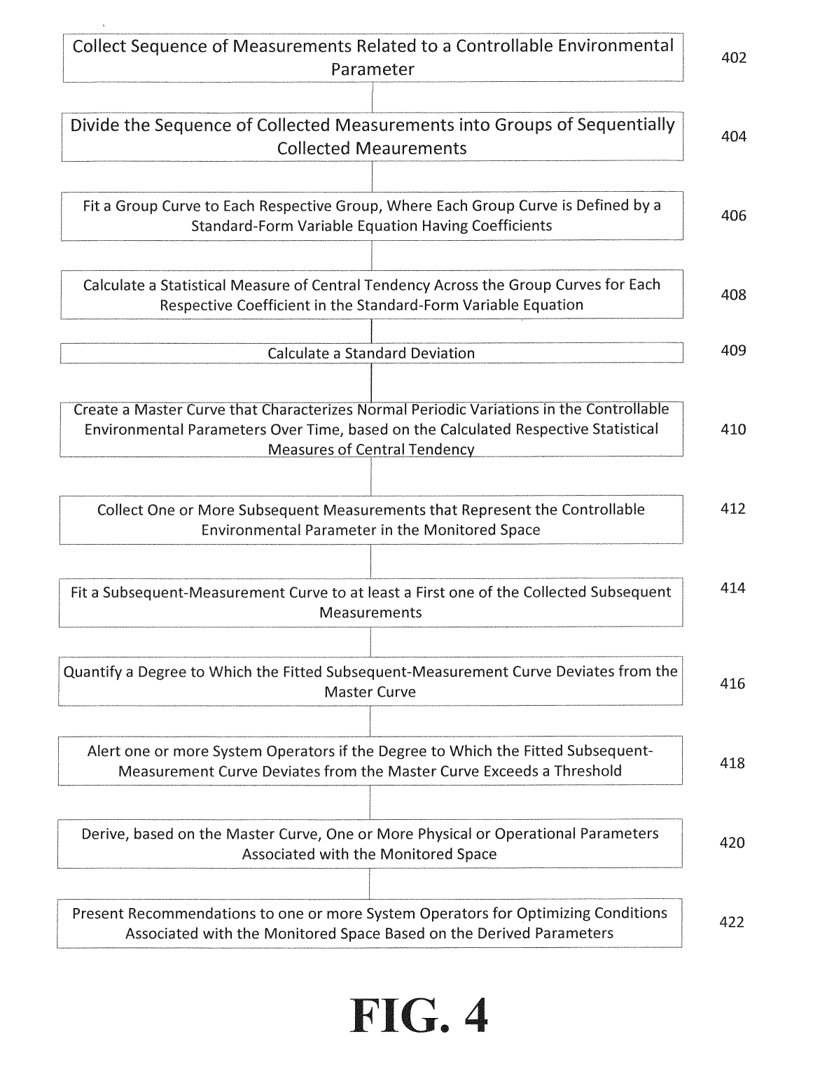

FIG. 4 is a flowchart showing an example of the techniques that the server 108 of FIG. 1 is able to perform or facilitate.

According to FIG. 4, the server 108 (at 402) collects a sequence of measurements related to a controllable environmental parameter. In the system of FIG. 1, for example, the controllable environmental parameter might be a temperature inside an associated one of the refrigerated containers 102a-102n. The temperature inside each container is generally controllable by virtue of its associated cooling system 104a-104n and thermal insulation.

The sequence of measurements (e.g., temperature measurements) may be collected from one of the sensors 106a-106n associated with a particular container. In this regard, the sensor may sense temperature inside the container and periodically transmit one or more sequential temperature measurement(s) to the server 108 over the communications network 112. The sequence of measurements represents the controllable environmental parameter, including any variations of the controllable environmental parameter, over time.

According to the illustrated method, the server 108 (at 404) divides the sequence of collected measurements into different groups of sequential measurements. If, for example, a sequence of seven measurements (numbered 1-7) had been collected, the server 108 might divide that sequence into three groups of five sequential measurements. In that example, measurements 1-5 would form the first group, measurements 2-6 would form the second group, and measurements 3-7 would form the third group. A sequence of collected measurements could, of course, be divided in any number of ways into different groups of sequential measurements.

Once the sequence of measurements has been divided into different groups of sequences, the server 108 (at 406) fits a group curve to each group of sequences. To do this, the server 108 can apply virtually any type of curve fitting technique or combination of techniques to produce a curve that accurately approximates each respective group of sequential measurements. In general, curve fitting entails constructing a curve, or mathematical function, that has the best fit (or at least a very good fit) to a series of data points, possibly subject to constraints. Curve fitting can involve interpolation, smoothing, or other techniques. Fitted curves can be used as an aid for data visualization, to infer values of a function where no data are available, and to summarize the relationships among two or more variables.

In a typical implementation, the curve fitting yields a curve that can be represented by a mathematical function. Given the roughly cyclical variation of temperature in a refrigerated container (due, for example, to compressor cycling) the mathematical functions may be standard variable-form equations, such as a quadratic equation having a form of f(x)=a₀x²+a₁x+a₂ or a cubic equation having a form f(x)=a₀x³+a₁x²+a₂x+a3, where x is time and where a0, a1, a2 and a3 are coefficients of the respective standard-form variable equations. Other forms of equations are possible as well.

The process of fitting a group curve to each respective group of sequentially collected measurements (at 406) yields multiple different group curves—typically, one curve for each group.

Next, the server 108 calculates (at 408) a statistical measure of central tendency for each coefficient of the equations that define the different group curves. The statistical measure of central tendency can be any kind of statistical measure of central tendency such as, for example, a mean (or average) value, median value or mode.

As an example, assume that process step 406 yields three different group curves, respectively defined by the following three equations:

f(x)=a₀x²+a₁x+a₂ (for group 1),

f(x)=b₀x²+b₁x+b₂ (for group 2), and

f(x)=c₀x²+c₁x+c₂ (for group 3),
where a₀, a₁ and a₂ are the coefficients for group curve 1,
b₀, b₁ and b₂ are the coefficients for group curve 2, and
c₀, c₁ and c₂ are the coefficients for group curve 3.

In that case, the server 108 might (at step 408) calculate a mean value for each coefficient to use in defining a new “master” curve. The server 108, in this regard, applies the following equations to calculate the respective mean values:

mean₀=(a₀+b₀+c₀)/3

mean₁=(a₁+b₁+c₁)/3

mean₂=(a₂+b₂+c₂)/3

At 409, the server 108 calculates a standard deviation for each of the coefficients (mean₀, mean₁, and mean₂) of the master curve. In general, standard deviation shows how much variation exists from an average (mean), or expected value. A low standard deviation generally indicates that the data points tend to be very close to the mean; high standard deviation indicates that the data points are spread out over a large range of values.

The server 108 (at 410) creates a master curve (or equation) that characterizes normal periodic variations in the controllable environmental parameter (e.g., temperature) over time. It does this based on the calculated respective statistical measures of central tendency (i.e., mean₀, mean₁, mean₂). Thus, the equation that defines the master curve in this example would be:

f(x)=mean₀x²+mean₁x+mean₂,
where x is time, and
where mean₀, mean₁, and mean₂ are coefficients of the equation.

There are, of course, other ways to derive a master curve that characterizes normal periodic variations in a controllable environmental parameter.

After deriving the master curve that characterizes normal periodic variations in a controllable environmental parameter, the server 108, according to the illustrated method, continues to collect data. More particularly, the server (at 412) collects one or more subsequent measurements that represent the controllable environmental parameter inside the monitored space (e.g., temperature measurements inside the corresponding refrigerated container).

The server 108 (at 414) then fits a subsequent-measurement curve to at least one of the subsequently collected measurements. In fitting the subsequent-measurement curve, the server 108 typically considers at least one of the subsequently collected measurements and one or more other measurements that were collected sequentially (before or after) relative to the subsequently collected measurement under consideration. Standard curve-fitting techniques can be applied to fit the curve to the associated measurements. Additionally, in a typical implementation, the subsequent-measurement curve is of the same form (e.g., a quadratic or cubic equation) as the master curve. An example of a subsequent-measurement (s-m) curve is:

f(x)=sm₀x²+sm₁x+sm₂,
where x is time, and
where sm₀, sm₁, and sm₂ are coefficients.

Next, at 416, the server 108 quantifies a degree to which the fitted subsequent-measurement curve (defined by f(x)=sm₀x²+sm₁x+sm₂) deviates from the master curve (defined by f(x)=mean₀x²+mean₁x+mean₂). There are a variety of possible ways to do this. However, as one example, the server 108 may determine a standard deviation for one or more of the respective coefficients (i.e., mean₀, mean₁, mean₂) from the master curve equation. The server 108 may then calculate a z-score for each corresponding coefficient (i.e., sm₀, sm₁ or sm₂) in the subsequent-measurement curve. In general, a z score indicates by how many standard deviations an observation or datum is above or below a mean value. Then, to evaluate the likelihood that the controllable environmental parameter will, at some future point in time, exceed an acceptable level, the server 108 may determine whether one or more of the calculated z-scores exceeds a corresponding threshold.

At 418, the server 108 alerts one or more system operators if the degree to which the fitted subsequent-measurement curve deviates from the master curve exceeds a threshold. The alert can take any one of a variety of forms. However, in general, the server 108 makes available to operator information that indicates that the operator may want to consider taking some action to rectify matters. For example, in some implementations, the server 108 sends a text message or sends an email to an account that the operator can access from his or her user interface device 110a-110n. In some implementations, the server 108 posts the alert to a website that the operator can access from his or her user interface device 110a-110n. Other methods of alerting the operator are possible, as well (e.g., phone calls, etc.).

In some implementations, the alert is generic (i.e., merely identifying that some problem, such as exceeding a threshold temperature is going to happen). In some implementations, the alert is more specific (e.g., that a door to the refrigeration device appears to have been left ajar or the compressor has failed to cycle on, etc.).

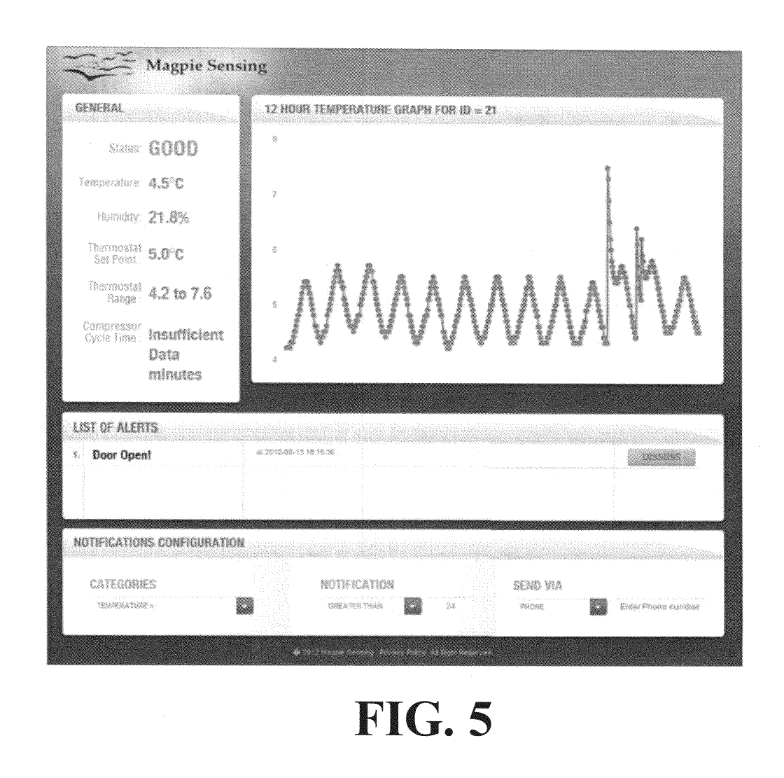

FIG. 5 is an exemplary screenshot that includes various information about a refrigerated container being monitored by the system and alerts, if any, regarding that container.

The illustrated screenshot includes a “General” information section that provides a status of the refrigerated container (“good”), a current temperature (“4.5° C.”) inside the container, a current humidity reading (“21.8%”) from inside the container, a thermostat range (“4.2 to 7.6,” which may have been manually entered into the system or derived based on information received from the sensor in that container), and a compressor cycle time (“insufficient data minutes”).

The illustrated screenshot also includes a “12 Hour Temperature Graph for ID=21” graphical plot of temperature versus time. The illustrated time scale (represented in the horizontal direction) spans approximately 12 hours and the illustrated temperature scale (represented in the vertical direction) range from about 4° C. to about 8° C. The graphical plot follows a substantially cyclical path (cycling between approximately 4.2 to 4.4° C. at the low end and about 5.5 to 5.7° C. at the high end for most of the 12 hour period). The plot diverts from the substantially cyclical path a few time toward the last portions of the recorded time, where the temperature reached as high as 7.6° C. at one point.

The illustrated screenshot has a “List of Alerts” that shows one alert (“Door Open!”) at a specified time. The illustrated screenshot includes a “Dismiss” button that the operator can select, for example, to acknowledge either having received the corresponding alert or having acted to address the system condition underlying the alert. In a typical implementation, once the “Dismiss” button is selected, the corresponding alert is removed from the illustrated screenshot.

The illustrated screenshot includes a “Notifications Configuration” section that enables a user to configure the system to provide various types of notifications to the user. The illustrated screenshot enables the operator to specify a category (e.g., temperature) for the notification, a notification condition (e.g., greater than x degrees) and a delivery method (e.g., send a text message via phone to a specified phone number).

In some implementations, the illustrated screenshot is emailed to the operator at various points in time (e.g., periodically or upon the occurrence of a specified event, such as an alert). In some implementations, the illustrated screenshot can be accessed anytime on a website accessible by the operator.

Referring again to FIG. 4, according to the illustrated method, the server 108 (at 420) derives, based on the master curve, one or more physical or operational parameters associated with the refrigerated container. These physical or operational parameters can include operational settings of the refrigeration control system, average rate of heat transfer through the container, etc.

If the server 108 identifies one or more ways that operation of a refrigerated container might be improved, the server 108 (at 422) presents to that container's operator (e.g., by text message, email, webpage update, phone call, etc.) one or more recommendations in this regard. The recommendations generally relate to one or more physical parameters of the refrigerated container or one or more operational parameters associated with the refrigerated container or its control system. For example, the recommendation may include lowering an operational target temperature for the container, or changing a range of acceptable temperatures for the container, or adding a heat sink material into the container, or fixing a seal around the door to the container, etc.

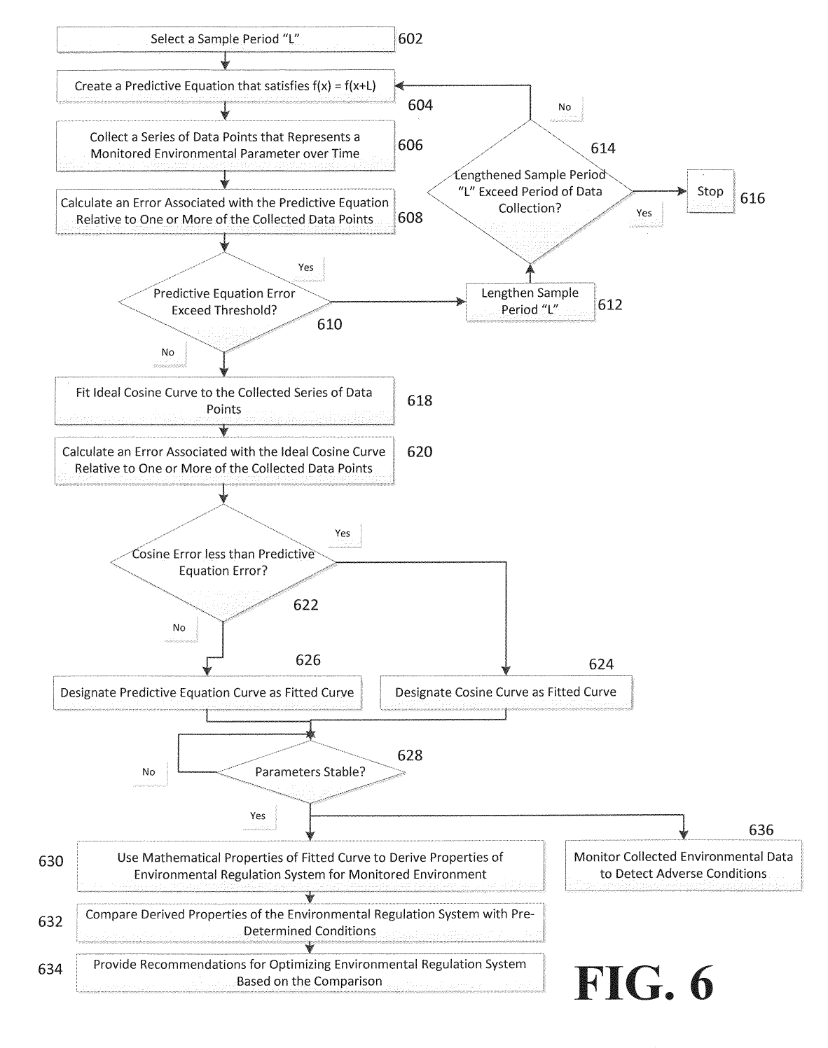

FIG. 6 is a flowchart showing an alternative example of the techniques that the server 108 of FIG. 1, for example, may be able to perform or facilitate.

In some implementations, environmental data is periodically collected from an environment whose conditions are regulated by an environmental control system. Environmental data may include temperature, humidity, light levels, airborne dust levels, presence and intensity of ionizing radiation, or vibration and other mechanical properties of the regulated environment. A person of ordinary skill in the art will recognize that other parameters of the regulated environment may be collected as well. The regulated environment may include any kind of container including a box, chamber, room, building or any other physical space whose environmental properties differ from those of the spaces physically adjacent to or surrounding it. The environmental control system may include a cooling system, heating system, ventilation system, and/or any other type of system that either actively or passively controls the environmental properties of the regulated environment.

Environmental data collection may consist of sampling the state of the regulated environment using an electronic sensing system (e.g., with sensor 106), analog sensing systems such as a thermometer or hygrometer, or any other method which allows the environmental properties of the regulated environment to be deduced and recorded. Environmental data collection may be performed at intervals of seconds, minutes, hours, days, weeks, etc. Any collection interval could be used as well, and the collection interval may be dependent on the collection method used or on other particularities of a given situation. Moreover, regulated environments other than those described above may be monitored, and environmental regulation devices other than those described may be used to control the regulated environment.

As environmental data is periodically collected, an ideal line, curve or function (e.g., a master curve) is fitted to the gathered data, such that the points in the ideal line, curve or function at a particular point in time deviate as little as possible from the empirical environmental data collected at that time. To accomplish this, as each new point of environmental data is gathered, a check is performed in order to determine if a periodic line, curve or other function can be used to accurately describe the environmental data point and all other data points collected for the same environmental parameter during some previous span of time. In general, the term “periodic line, curve or other function” (or master curve) can refer to any continuous or non-continuous mathematical formula, equation or process that generates a series of multidimensional coordinates whose values are substantially periodic relative to time (e.g., that substantially repeat over some span of time).

Such a periodic line, curve or other function may exist even if the value of the environmental parameter does not change over time; in this case, the periodic line, curve or other function would have a mathematical period equal to zero. Additionally, several periodic lines, curves or functions may be fitted to gathered data, all of which may be integrated into a single meta line, curve or function, or that a periodic line, curve or function may include one exemplary line, curve or function and a series of additional lines, curves or functions which are statistically similar to the exemplary line, curve or function. A periodic line, curve, or other function shall be considered to accurately describe a sequence of environmental data points if the error observed during a certain time is less than a given value. Error may be defined as the difference between the predicted value of an environmental variable at some point in time generated by a periodic line, curve or other function and the actual collected value of the environmental parameter at that same point in time. Error may also be defined as the Euclidian distance between the actual collected value of the environmental parameter and value predicted by a periodic line, curve or other function. Other methods of defining and/or calculating error may be used as well.

Error as used herein may refer to the error observed at a particular discrete point in time, the average or median value of error as observed over multiple data points, or some other means of representing an aggregate error in a sequence of data points. In one exemplary embodiment, a periodic line, curve or function may be considered to accurately describe a series of temperature readings if the server 108, for example, determines that the average error is less than 10%. An error amount of more or less than 10% could be used or that environmental parameters other than temperature could be collected. Furthermore, some method could be used to determine whether a periodic line, curve or function accurately describes a series of environmental data points, or that some periodic line, curve or function may accurately describe a series of environmental data points over some span of time while failing to accurately describe a series of environmental data points over some lesser or greater span of time.

According to the illustrated implementation, to determine if a periodic line, curve or other function can be used to accurately describe a collected environmental data point and all other data points collected for the same environmental parameter during some previous span of time, the server 108 (at 602) chooses a sample period L. The sample period L may be a time in seconds, minutes, hours or any fraction thereof.

The server 108 then uses the sample period L (at 604) to create a predictive equation of the form f(x)=f(x+L), where x is time and L is the sample period.

The server 108 (at 606) collects a series of data points and stores them for a time period equal to the time at which the most recent environmental data point was gathered minus some value greater than L. An appropriate value when measuring temperature data may be 3*L, although any time period longer than L could be used.

For each collected environmental data point in this series, the server 108 applies the predictive equation to calculate (at 608) a predicted value for the environmental parameter x at the same time point at which the collected environmental data point was gathered. One or more errors for the sequence of collected environmental data points is recorded.

If the server determines (at 610) that the error is below some threshold value, the predictive equation may be considered to accurately describe the series of collected data points.

If the server determines (at 610) that the predictive equation does not accurately describe the series of environmental data points, L is incremented (at 612) by some value, and the above procedure is repeated until a value of L is found which produces a predictive equation accurately describing the series of environmental data points.

If the server determines (at 614) that L has been incremented such that the time span comprising L subtracted from the time of the most recently collected environmental data point exceeds the time span comprising the first available environmental data point for a particular measurement period in question subtracted from the time of the most recently collected environmental data point, and an accurate predictive equation is not generated, the procedure stops (at 616) and is considered to have failed. As new environmental data points are gathered, the procedure may be repeated until an accurate periodic line, curve or other function is determined to exist.

A predictive equation of a form other than f(x)=f(x+L) may be used. Moreover, any threshold values discussed above may be set using any of a variety of methods, these threshold values may change over time, and/or a different method may be used to determine an initial value for L. Additionally, many values of L may be used to create a predictive equation which accurately describes the series of environmental data points in question. A modification of the above procedure may include ranking different values of L based on the accuracy of the predictive equations generated therefrom, and choosing that L which generates the most accurate predictive equation. Moreover, some procedure other than the procedure described above may be used to determine if a periodic line, curve or other function can be used to accurately describe a collected environmental data point and all other data points collected for the same environmental parameter during some previous span of time. Furthermore, no periodic line, curve or other function may exist which accurately describes a given series of environmental data points, in which case the above procedure or some other procedure may be repeated indefinitely without a result, the threshold for determining accuracy may be decreased, or the procedure may be terminated after a certain number of attempts, with the conclusion that the environmental parameter being monitored does not vary periodically.

Once a periodic line, curve or other function is found which can be used to accurately describe a collected environmental data point and all other data points collected for the same environmental parameter during some previous span of time, a check may be performed to determine if an ideal cosine curve can be used to more accurately describe the data points than the equation of the form f(x)=f(x+L). This can be accomplished, for example, by determining the difference between the value of an environmental parameter at one point in time and the value of that same parameter at some previous point in time (defined here as ΔV), as well as determining the amount of time which passed between collection of the two points of data on the value of the environmental parameter (defined here as Δt). For example, if temperature is being monitored, for each collected data point on the temperature of a regulated environment, the difference between the temperature at that data point and the temperature at a previous point is calculated, as is the duration of time which has passed between the current temperature measurement and the previous one. As environmental data is collected, maximum and minimum values of V are determined. This is accomplished by determining whether ΔV is positive or negative at each point in time when environmental data is collected. If ΔV is found to be positive, ΔV is monitored until an environmental data point is gathered for which ΔV is negative. This data point is labeled a guessed maximum. If ΔV remains negative for the next several data points, the guessed maximum is considered a confirmed maximum. If ΔV becomes positive within several observations of the guessed maximum, the guessed maximum is abandoned, and the procedure is repeated until a confirmed maximum is found. As used herein, the term “several data points” generally means one or more additional data points collected after a guessed maximum has been observed. If ΔV is determined to be negative at a particular point in time, the above described procedure is performed in reverse to determine guessed and confirmed minimums rather than guessed and confirmed maximums.

The above described procedure results in a series of maximum and minimum values of V. The server 108 then applies (at 618) an estimation method to fit an ideal cosine curve to these values. To accomplish this, several terms may be defined for a particular set of maximum and minimum values of V. These terms include Amplitude (the difference in the value of the environmental parameter between a maximum of V and a minimum of V), Period (the difference in time between a maximum of V and a minimum of V), and Trend Line (the median value of the environmental parameter between a maximum of V and a minimum of V). The estimated cosine curve is then given by the equation EV=α cos(βt)+γ where EV is the estimated value of the environmental parameter at a given point in time, α is the value of Amplitude at the point in time divided by 2, β is equal to 2π/Period for that point in time, γ is equal to the value of the environmental parameter at the last maximum of V, and t is the time which has passed between the point of time in question and the time at which the last maximum value of V was observed.

For each newly collected environmental data point which is determined to be a confirmed maximum or confirmed minimum, EV is calculated as described above, given that at least one confirmed maximum or confirmed minimum has been previously determined. Error is then calculated (at 620) according to the method described above, using EV as the predicted value to be compared to empirically gathered data. One of ordinary skill in the field will recognize that another method of fitting a cosine curve to collected environmental data could be used. One will further recognize that a different means of determining minimum and maximum values of V could be used, or that some method other than determining minimum and maximum values of ΔV could be used to fit an ideal cosine curve to the collected environmental data, such as the use of regression or other statistical means of fitting a curve.

The term “fitted function” may refer, for example, to the periodic line, curve or other function which can be used to most accurately describe a collected environmental data point and all other data points collected for the same environmental parameter during the span of time being considered. If the error value obtained by using the above-described cosine fitting method is determined by the server (at 622) to be less than the error value obtained by using the previously described function of the form ƒ(x)=ƒ(x+L), the ideal cosine curve derived from the above described cosine fitting method is designated (at 624) to be the fitted function. Conversely, if the error value obtained by using the above-described cosine fitting method is determined by the server (at 622) to be greater than the error value obtained by using the previously described function of the form ƒ(x)=ƒ(x+L), the previously derived function of the form ƒ(x)=ƒ(x+L) is designated (at 626) to be the fitted function. The term EV may refer generally to the value of ƒ(x) in an equation of the form ƒ(x)=ƒ(x+L).

Some method other than the above may be used to determine the fitted function for data obtained over some period of time, or that a curve, line or function type other than the two types described above may be used. Additionally, different fitted functions may be used to describe environmental data gathered over different time spans, and a fitted function may prove accurate during one time span, but may not be accurate over some longer or shorter time span. Finally, multiple fitted functions may need to be calculated, should multiple environmental parameters be collected, and that these multiple fitted functions may be calculated using different methods depending on the nature of the environmental parameter being collected.

In another implementation, a statistical method is applied to fit an ideal line, curve or function to gathered environmental data. In this statistical method, as data points are received, a period L is chosen, such that the period L is some span of time previous to the time at which the most recent data point was received, and such that at least a certain number of data points have been received during the period L. The period L may be a span of seconds, minutes, or hours. The certain number of data points may be any number greater than 1. If the environmental data being gathered is temperature data, and the monitored environment is the chamber of a refrigeration device, the period L may be a length of time equal to 6-12 hours. Lengths of time other than 6-12 hours may be chosen. Once a period L has been determined, for each data point Q(a) gathered during period L, a quadratic or cubic equation of the form Q(a)=a₀x²+a₁x+a₂ is chosen such that the line formed by the equation minimizes error for the point Q(a) and a certain number of points preceding it. If temperature data is being monitored, the certain number of points preceding Q(a) may be five, but one of ordinary skill in the field will recognize that another number of points could be used as well. One of ordinary skill in the field will recognize that for the first several points gathered during period L, a quadratic or cubic equation may not be able to be determined, as the certain number of points chosen for the analysis may not yet have been gathered. For example, if the certain number of points is five, and the first point in period L is being analyzed, five points have not yet been gathered previous to the first point in L, and so a quadratic or cubic equation cannot be determined.

After quadratic or cubic equations have been determined for all points gathered during the period L for which such an equation may be determined, the mean and standard deviation of the coefficients a₀, a₁, and a₂ are calculated, taking into account the values of these coefficients for each quadratic or cubic equation fitted to each point gathered during period L. This is used to form a single master quadratic or cubic equation of the form Q (a)=a₀x²+a₁x+a₂, where a₀, a₁, and a₂ are equal to the mean of the values of a₀, a₁, and a₂ for all quadratic or cubic equations fitted to all points during period L. This master quadratic equation is determined to be the fitted function.

Once an ideal line or curve has been fitted to the environmental data gathered during a particular period of time, a check is performed by the server 108 (at 628) to determine if the parameters of the environment are stable during some future period of time. Stability can be generally defined as a state in which a particular fitted function accurately describes the environmental data being collected, with error remaining below a certain pre-determined level. This pre-determined level may vary depending on the environment being regulated, accuracy of the collected environmental data, or other factors. If the fitted function is of the cosine type described above, stability may be defined as any situation where the standard deviation of the previous two maximums and minimums of an environmental variable is less than a certain value, the standard deviation of the previous two periods is less than a certain span of time, and error (calculated using Euclidean distance as described above) is less than a particular number of units. By way of example, if the environmental parameter being measured is temperature and data is collected every 20 seconds, the system may be considered stable when the standard deviation of the previous two temperature maximums and minimums is less than 0.2 degrees Celsius, the standard deviation of the previous two periods is less than 5 minutes, and error calculated using Euclidean distance is less than 1.5 units. Threshold values other than 0.2 degrees Celsius, 5 minutes and 1.5 units may be used to determine stability, that data may be collected more or less frequently than every 20 seconds, and that the same method may apply to environmental parameters other than temperature.

If the fitted function is of the form ƒ(x)=ƒ(x+L), stability may be defined differently, by checking the parameters of the function to ensure that they are consistent over time. If the fitted function is of the form Q(x;a)=a₀x²+a₁x+a₂, stability may be determined by first calculating a new quadratic equation of the form Q(x; c)=c₀x²+c₁x+c₂. In this example, a0, a1, and a2 would represent mean values. Each parameter, a0, a1, and a2, therefore, has a standard deviation associated with it to summarize the spread of the data. Let's call these values sd0, sd1, sd2. The server 108 then calculates the z-score of each new parameter, c0, c1, c2 is computed as:

z0=(c0−a0)/sd0

z1=(c1−a1)/sd1

z2=(c2−a2)/sd2

Stability may be then defined as any situation where the z score of one, two or all of the coefficients is less than a certain threshold value. This threshold value may be 3, but one of ordinary skill in the field will recognize that other threshold values could be used as well.

Stability may be determined using a method other than the methods described above, and that stability may be defined differently for fitted functions of types other than the types described previously. Further, the system may be considered stable over a certain period of time even if it is not stable over some longer or shorter period of time, and the time span used to establish stability may vary based on nature of the regulated environment, the accuracy of the collected data, or other factors.

Once a fitted function has been derived, and once stability has been achieved over some period of time, the server 108 uses the mathematic properties of the fitted function to determine (at 630), for example, the properties of the environmental regulation system controlling the regulated environment, or properties of the environment itself. For example, if the environmental regulation system is a refrigeration compressor and its associated refrigeration system components, the environmental parameter being collected may be temperature, and the above described cosine fitting method is used to fit an ideal cosine curve to the collected temperature data, the period of the ideal cosine curve would correspond to the duty cycle of the refrigeration compressor, the trend line would show the set point(s) of the thermostat or control device used by the refrigeration compressor, and the amplitude of the ideal cosine curve would correspond to the range of the thermostat or control device used by the refrigeration compressor.

Mathematic properties other than those identified above could be used, for example, different properties of a refrigeration compressor could be derived, and environmental parameters other than temperature could be used. Additionally, a line or curve other than an ideal cosine curve could be used, in which case mathematic properties other than period, trend line and amplitude may be used to derive properties of the environmental control system. For example, if the fitted function were of the form ƒ(x)=ƒ(x+L), then the period of the function would correspond to the duty cycle of the refrigeration compressor in the above example, the average difference between the maximum and minimum values of the function over some period of time would correspond to the range of the thermostat or control device used by the refrigeration compressor, and the median value of the function over some period of time would correspond to the set point of the thermostat or control device used by the refrigeration compressor. In any of the examples provided above, if the regulated environment is the chamber (inner compartment) of a refrigerated container, the derivative of the fitted function at a point in time when the fitted function is trending upwards would correspond to the rate of cold loss of the refrigeration device's chamber. Properties of an environmental control system other than a refrigeration compressor can be derived, and properties of a refrigeration compressor which does not utilize a thermostat or similar control device can be determined.

Once properties of the environmental regulation system have been determined, the server 108 may use a recommendation engine (implemented, for example, by virtue of the processor 303 executing the software 308) to provide one or more recommendations for optimizing the environmental regulation system for a particular regulation need. The functionalities of the recommendation engine may be presented to a system operator as a web application, software application, embedded firmware application, or any other system which is able to evaluate certain conditions and provide visual, auditory, or other information based on the results of the evaluation.

The recommendation engine may provide recommendations to one or many parties, including the party responsible for the integrity of the monitored environment, a regulatory agency regulating the products stored in the monitored environment, or some other party.

In general, the recommendation engine compares (at 632) the derived properties of the environmental regulation system with pre-determined conditions. Based on these conditions, the recommendation engine then provides recommendations (at 634), if appropriate, for altering the properties of the environmental regulation system, or taking some other action. For example, if the environmental regulation system is a refrigeration compressor, the regulated environment is the chamber of a refrigeration device, the environmental parameter being collected is temperature, the derived range of the thermostat controlling the refrigeration compressor is 4 degrees Celsius, the derived set point of the thermostat controlling the refrigeration compressor is 2 degrees Celsius, and the recommendation engine is configured to prevent conditions where the temperature of the regulated environment falls below 0 degrees Celsius, the recommendation engine may provide a recommendation to increase the set point of the thermostat controlling the refrigeration compressor by 2 degrees Celsius or more, so that the temperature of the regulated environment will not fall below 0 degrees Celsius. In the same example, if the derivative of the fitted function, during a period where the fitted function is trending upwards, is greater than a certain value, the recommendation engine may determine that the chamber of the refrigeration device is losing cold at too high a rate, and may recommend checking the insulation of the chamber, adding water bottles or other buffers to the chamber, or taking some other action to reduce the rate of cold loss. The certain value may be the average value for a refrigeration device manufactured by a certain party, or may be some other value.

The recommendation engine may be configured to provide a variety of other recommendations regarding environmental parameters, properties of the environmental regulation system, and/or pre-configured or derived environmental conditions which must be met or avoided. These recommendations may be based on laws or requirements for environmental regulation provided by the Centers for Disease Control, Food and Drug Administration, or another governmental or regulatory body. Further, the recommendations may be based on parameters of the items stored in the regulated environment. For example, if the regulated environment is a refrigerator device's chamber and vaccines are stored in the chamber, the recommendations provided by the recommendation engine may be based on the temperature tolerances of the specific vaccines being stored. The recommendation engine may provide recommendations for actions other than changes to the environmental regulation system, or may automatically take some action to effect change rather than simply providing a recommendation.

Once stability has been obtained, the server 108 monitors (at 636) collected environmental data to detect potentially adverse conditions, where the environmental parameters of the regulated environment have exceeded or may exceed specific bounds. In general, the server 108 is able to do this in advance of any significant problems occurring. The potentially adverse conditions may occur due to a failure of the environmental control system, a change in the properties of the regulated environment, or for some other reason. For example, if the environmental control system being regulated is a refrigeration compressor and the regulated environment is the chamber of a refrigerator device, a failure may occur due to mechanical breakdown of the compressor, lack of electrical power for the compressor, or a change in the properties of the refrigerator device chamber, such as the refrigerator device door being left open or the contents of the refrigerator device chamber being suddenly changed. Adverse conditions may be identified by detecting a condition where stability is obtained for some time period, and stability is then lost after that time period. If the cosine fitting method described above is applied to determine the fitted function, stability may be lost if the error is above a certain threshold, or if the standard deviation of the previous two maximums and minimums of an environmental variable exceeds a certain value. If the fitted function if of the form ƒ(x)=ƒ(x+L), stability may be lost if the error is above a certain threshold, or if other parameters of the function deviate from observed parameters of the environment. If the fitted function is of the form Q(a)=a₀x²+a₁x+a₂, stability may be lost if the z score of c₀, c₁, and/or c₂ exceed a threshold value.

Other methods for determining a loss of stability may be used. Moreover, the thresholds used to identify a loss of stability may be different for different environmental parameters or monitored environments. Stability may be considered lost only if an apparent loss of stability has been observed for more than a certain pre-determined length of time. Adverse conditions may also be present if the actual value of an environmental parameter exceeds the absolute value of EV at a certain point in time by a certain margin, or continues to exceed the absolute value of EV for a certain number of discrete, consecutive or adjacent time points. Means other than those described above may be employed to detect adverse conditions.

Following detection of adverse conditions, the recommendation engine provides recommendations (e.g., via text message, email, webpage update, etc.) for restoring the stability of the regulated environment. This may involve recommendations for changes to the environmental control system, or changes to the regulated environment. For example, if the environmental regulation system is a refrigeration compressor, the regulated environment is the chamber of a refrigerator device, the environmental parameter being collected is temperature, and adverse conditions comprising a sudden upward spike in temperature are detected, the recommendation engine may produce a recommendation to check the state of the refrigerator device's door to ensure it is not ajar, or to check the state of the refrigeration compressor to ensure it has not failed.

These recommendations may be based on known properties of the environmental control system being measured, collected environmental data, or the nature of the detection method used to identify the adverse conditions. For example, in the scenario described above, a sudden change in the temperature of the refrigerator device's chamber (indicated by a large deviation between the actual temperature of the chamber and the predicted temperature EV), may indicate that the refrigerator device's door had been left ajar, resulting in a sudden influx of warm air into the chamber. Conversely, a slow change in the temperature of the refrigerator device's chamber, as detected by a loss of stability over a longer span of time, might indicate a failure of the refrigerator device's compressor, a loss of electrical power, or another environmental condition which would produce a slow change in chamber temperature. The rate of change may be determined by taking the first derivative of the fitted function at a particular point in time, or by some other method. The recommendation engine may use other means to provide recommendations for correcting adverse conditions.

In providing recommendations, the recommendation engine may calculate the forecasted time before adverse conditions are projected to result in an environmental bound being exceeded. In the above scenario, for example, this might be the time before the refrigerator device's chamber reaches a temperature which would result in spoilage of stored products. One of ordinary skill in the field will recognize that many adverse conditions may ultimately lead to environmental bounds being exceeded, and that forecasting of the time to an environmental bound crossing may be valuable for environmental parameters other than temperature and environmental control systems other than a refrigeration system. To forecast the time until an adverse event results in an environmental bound crossing, time until bound crossing may be determined by the equation

$$TL = \frac{( bound - currentValue )}{σ} ,$$

where TL is time left until a bound crossing, bound is the pre-determined environmental bound, currentValue is the current value of the environmental parameter being measured, and σ is the per-minute change in the environmental parameter. σ may be derived using any of a variety of possible methods. If the fitted function is an ideal cosine curve as described above, σ may be defined as the derivative of the cosine curve at any given point in time, or

$$\frac{d}{d t}$$

(α cos(βt)+γ).

A previously determined value of σ may also be used, based on the nature of the regulated environment, the environmental control system being used, and the frequency at which environmental data is collected. For example, if the environmental regulation system is a refrigeration compressor, the environmental parameter being collected is temperature, the regulated environment is the chamber of a refrigerator device, and the fitted function is an ideal cosine curve, σ may be estimated as

$$\frac{2 αβ}{π} .$$

If an environmental parameter is determined to change dramatically between two observations, σ may be set to ΔV as defined above. One of ordinary skill in the field will recognize that other methods may be used to determine σ, that the estimated value of σ may change over time, and that means other than those described above may be used to forecast the time before adverse conditions result in an environmental bound being exceeded.

Once adverse conditions have been detected and the recommendation engine has provided recommendations for restoring the regulated environment to a stable state, any of a variety of methods may be used to determine whether adverse conditions continue to exist. For example, the same fitted function may continue to be used, and adverse conditions may be considered to exist for as long as the system remains in an unstable state. Alternatively, adverse conditions may be considered to exist for a certain period of time, after which the entire procedure described above may be performed again, with a new time span defined to begin at the point where adverse conditions were detected, or at some later point in time. In this scenario, a new fitted function would be derived and applied. This may occur, for example, if the detected adverse conditions were not the result of actual adverse conditions in the regulated environment, but were rather than result of some deliberate change to the environment of the environmental control system. For example, if the operator of a refrigerator device changed the set point of the thermostat or other control device controlling the refrigeration system compressor, resulting in an increase in the temperature of the refrigerator device's chamber, adverse conditions may be initially detected until a new fitted function was derived to accurately describe the stable operation of the refrigerator device at its new thermostat set point. Operation of the system would then continue as normal.

A variety of other situations may exist in which adverse conditions are detected, and a new fitted function is eventually derived, or the regulated environment returns to a state where the original fitted function re-achieves stability. One will recognize that the recommendation engine may be configured not to provide recommendations under certain of these scenarios, or that the recommendation engine may provide a recommendation that a new fitted function be derived, based on some criteria determined by the engine.

Additionally, the recommendation engine may be employed to provide meta recommendations based on long term trends of stability or adverse conditions. For example, if stability is lost several times per day for several days, the recommendation engine may generate a recommendation based on this meta trend. The recommendation engine may further be used to report on trends to a party other than the party responsible for the integrity of the monitored environment. For example, the recommendation engine may provide a weekly summary of losses of stability to a regulatory agency responsible for regulating the contents of the monitored environment. This weekly summary may be in the form of a standard temperature chart, an automated summary email, or some other form.

### Example

By way of example, a complete description of a possible use of the above method and system is here provided. A physician wishes to store vaccines in a refrigerator device, such that the temperature of the vaccines neither exceeds 8 degrees Celsius nor reaches a point less than 0 degrees Celsius. The physician places a wireless sensing device in the refrigerator device along with the vaccines. The wireless sensing device measures the temperature of the refrigerator device at 20 second intervals, transmitting these measurements to a web server on which the above described system is implemented. The physician configures the recommendation engine to ensure that the temperature of the refrigerator device stays between 0 and 8 degrees Celsius. After a certain number of measurements are obtained, a cosine curve is fitted to the incoming data. Properties of the curve are used to derive properties of the refrigerator device. The set point of the refrigerator device's thermostat is determined to be 2 degrees Celsius, and the range of the thermostat is determined to be 3 degrees Celsius. The recommendation engine detects that this range will result in the chamber of the refrigerator device reaching −1 degrees Celsius at its coldest temperature. Because this value is less than the lower bound of 0 degrees Celsius, the recommendation engine sends a text message alert to the physician instructing the physician to increase the set point of the refrigerator device's thermostat to 4 degrees Celsius. The physician performs this action, and violation of the predefined temperature bounds is thus avoided.

At some later point in time, the derivative of the fitted function is used to determine that the refrigerator device loses cold at a rate of 2 degree Celsius per minute. The recommendation engine determines that this rate exceeds the average rate for other refrigerator devices from the same manufacturer. The recommendation engine sends a text message alert to the physician, who checks the seal on the refrigerator device's door. The seal is determined to be faulty, and is replaced. A new derivative is calculated, and the rate of cold loss is determined to be 1 degree Celsius per minute. The recommendation engine determines that this rate is still too high, and sends a text message alert to the physician recommending that the physician place water bottles or other buffers into the refrigerator device. The physician does so, the rate of cold loss for the refrigerator device is reduced to an acceptable level, and the refrigerator device's compressor no longer has to turn on as frequently to keep the refrigerator device's chamber cold, prolonging the life of the refrigerator device and saving the physician electrical costs.

At some later point in time, the physician opens the door of the refrigerator device and leaves it ajar. The temperature of the refrigerator device's chamber begins to increase, a loss of stability is detected, and the large change in collected temperatures is used to determine that the door has been left ajar. The recommendation engine alerts the physician that the door is ajar via an audible alert. The physician closes the door of the refrigerator device, the temperature begins to decrease, and a violation of the predefined temperature bounds is thus avoided. At some later point in time, the refrigerator compressor of the refrigerator devices experiences a mechanical failure at 5 am. The temperature of the refrigerator device's chamber increases, and a slow deviation between the predicted temperature and the actual collected temperature of the refrigerator device's chamber is observed. The recommendation engine concludes, based on this slow deviation that a compressor failure has occurred. The recommendation engine uses the above defined methods to estimate the time before the failure will result in an environmental bounds crossing. The forecasted time is determined to be 2 hours. The recommendation engine makes an automated phone call to the physician, altering the physician about the failure and the predicted 2 hour time to a bounds crossing. Knowing that a violation will occur in two hours, the physician knows that he or she need not immediately rush to his or her office to correct the failure. Instead, the physician arrives at his or her normal arrival time of 7 am, and transfers the vaccines to a different refrigerator device before temperature bounds are violated.

At a later point in time, the physician decides to participate in a clinical trial, in which a new drug will be stored in the physician's refrigerator device before being administered to the physician's patients. The drug's manufacturer requires confirmation that the physician is storing the drug properly. Each week, the recommendation engine looks at meta trends of stability losses during the previous week. These meta trends are automatically reported to the drug manufacturer via an automated email. The drug manufacturer is able to see that the physician is storing the drug correctly, since few stability losses are observed, and the physician is encouraged to continue their participation in the trial.

In some implementations, a device (e.g., a sensor, similar to the sensor shown in FIG. 2) is provided for monitoring the conditions of items in transit, and an associated method is provided for relaying information about the items' condition to a central server for monitoring, analytics and/or stakeholder notification. In a typical implementation, the device consists of a printed circuit board populated with several components, including a variety of sensors for monitoring environmental conditions, a cellular communication component for sending data over existing cellular networks, a microprocessor for reading data from the sensors, storing those data in persistent memory, encoding those data for transmission, and transmitting those data using the cellular transmitter, and a power regulation system which provides electrical power to the other components.

The sensor components of the device can measure a variety of factors related to the environment immediately surrounding the device, including temperature, humidity, barometric pressure, light intensity, and ionizing radiation intensity. Additionally, the sensor components can measure a variety of device states, including battery level, device acceleration, and the identifying information of nearby cellular towers. Other elements of the device's state and immediate environment may be measured by the sensor components as well.

The cellular component of the device can include a cellular transceiver that is able to authenticate with and connect to a cellular network using any desired cellular communications standard, and to transmit and receive information over the network. These standards may include 850, EGSM 900, DCS 1800 or PCS 1900 standards. Any other standard may be used as well. The device may utilize a SIM card to achieve authentication with local cellular networks, although this could be accomplished using other means of authentication. The cellular component utilizes an external SMA antenna, although another antenna technology, including an on-chip antenna, could be used as well. The cellular component is minimally able to transmit and receive Short Message Service (SMS) messages, although the component may also transmit and receive data using TCP/IP or other data transmission standards.

The microprocessor component consists of an ATMEGA 328P microprocessor operating at a frequency of 8 Mhz, and populated with firmware allowing reading of data from sensor components, storage of those data in persistent memory, encoding of the data, and transmission of those data over a cellular network using the cellular communication component of the device. The microprocessor component also includes external EEPROM memory for storing data before transmission. Another microprocessor could be used instead of the ATMEGA 328P, or that the microprocessor could operate at a frequency other than 8 mhz. Additionally, an external storage technology other than EEPROM could be utilized, and data storage can be achieved by other means.

The power component of the device may consist of a lithium polymer battery, lithium polymer charging circuit, charging power input jack, power filtering system, and voltage regulator. The lithium polymer battery may provide a raw voltage of 3.7 v with a capacity of 2000 milliamp hours, and includes a circuit for detecting over voltage and over current conditions. The lithium polymer charging circuit allows the battery to be charged using an input of between 3.7 and 7 volts. The charging power input jack may allow charging power to be supplied from a variety of sources, including but not limited to an external power supply, solar panel, or vehicle power system. The power filtering system may consist of a network of capacitors which are used to filter any undesired electrical noise present in power provided to the device either through the charging power input jack or from the lithium polymer battery. The voltage regulator may be used to regulate the voltage of power supplied to the device from the lithium polymer battery or charging power input jack to an appropriate level for the other components of the device. The voltage regulator may supply a different voltage or maximum current to each component on the board, or may provide multiple voltages for various subcomponents, including multiple sensing components requiring various voltages. A battery technology other than lithium polymer could be used, the battery could operate at a voltage other than 3.7 volts, the battery could provide a capacity other than 2000 milliamp hours, and the battery and charging circuit could be eliminated entirely.

The sensing components, microprocessor and transmission component communicate with each other electrically using UART, although another intra-device electrical communication standard could be used as well. All components typically are attached to a printed circuit board using Surface Mount Technology or Through Hole soldering methods, although another attachment method could be used. The printed circuit board may be designed to spatially isolate temperature-sensitive sensing components from heat-generating components of the device, although another isolation technique could be used. Other sensing components whose readings could be affected by elements of the device could be isolated from those elements using similar techniques. An In System Programming header may be provided for uploading compiled code to the device's microprocessor, although another uploading method could be used, or the ability to upload code to the device's microprocessor following manufacture of the device could be eliminated.

The device is generally intended to be placed in the immediate surroundings of goods which will be transported from one location to another via a shipment, such that the environment occupied by the goods is the same environment occupied by the device and will remain so throughout the duration of the shipment. This could involve placing the device in a box or other container into which the goods are also placed. This could also involve placing the device inside a vehicle, such as a truck or airplane, which contains the goods. This could further by achieved by any other method which ensures that the immediate environment of the device corresponds to the immediate environment of the goods. In this context, a shipment means any situation where a discrete set of goods travel from a single point of origin to a single final destination.

The device could also be employed to monitor multiple shipments simultaneously, should they share the same environment. During the shipment, the device's microprocessor component uses the device's sensor components to measure the device's immediate environment, and thus the immediate environment of the goods. Other components of the device may be used to measure other aspects of the device's environment or state. The device's microprocessor component then encodes these data for transmission and transmits them to a nearby cellular tower, where they are relayed over existing cellular networks to a gateway device. The gateway device un-encodes the data and sends it to a web server. The server stores the data in a database, and makes it available for display using a Graphical User Interface, such as through a web browser or mobile phone application. The web server may also perform statistical analyses of the data, and utilize a notification engine to inform stakeholders of notable trends in the data. The web server may also utilize a decision engine to transmit desired changes in the device's configuration back to the device using the gateway.

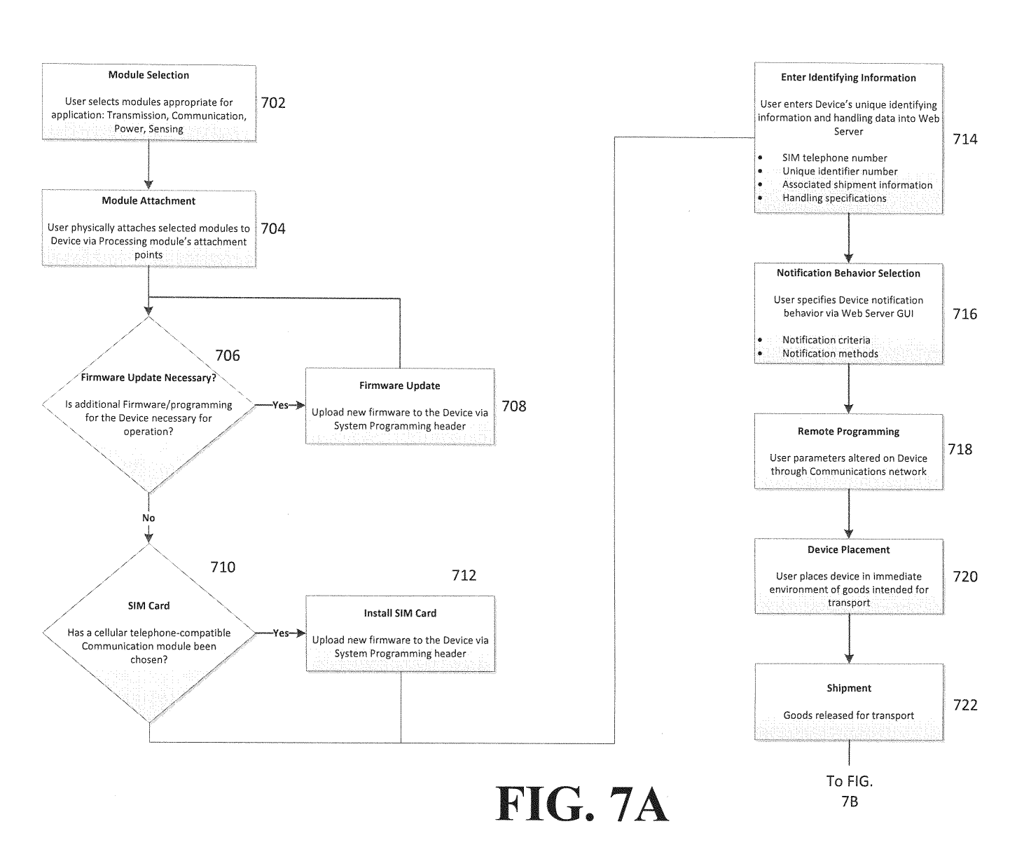

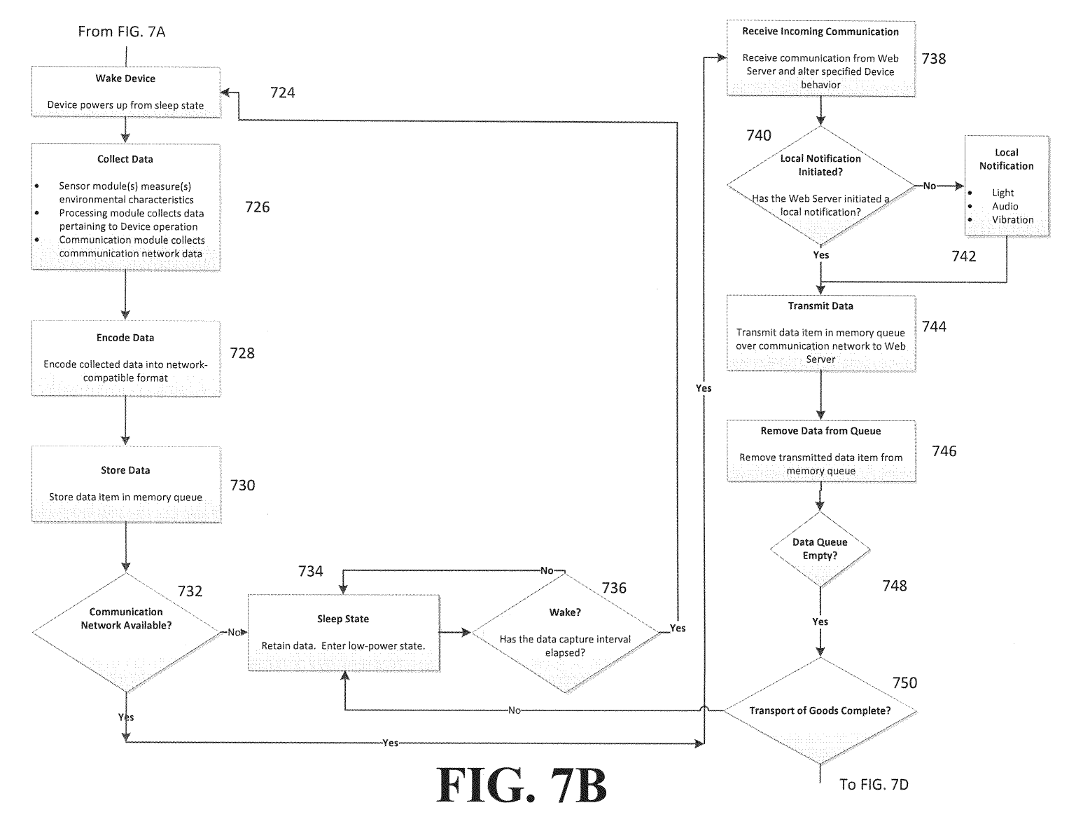

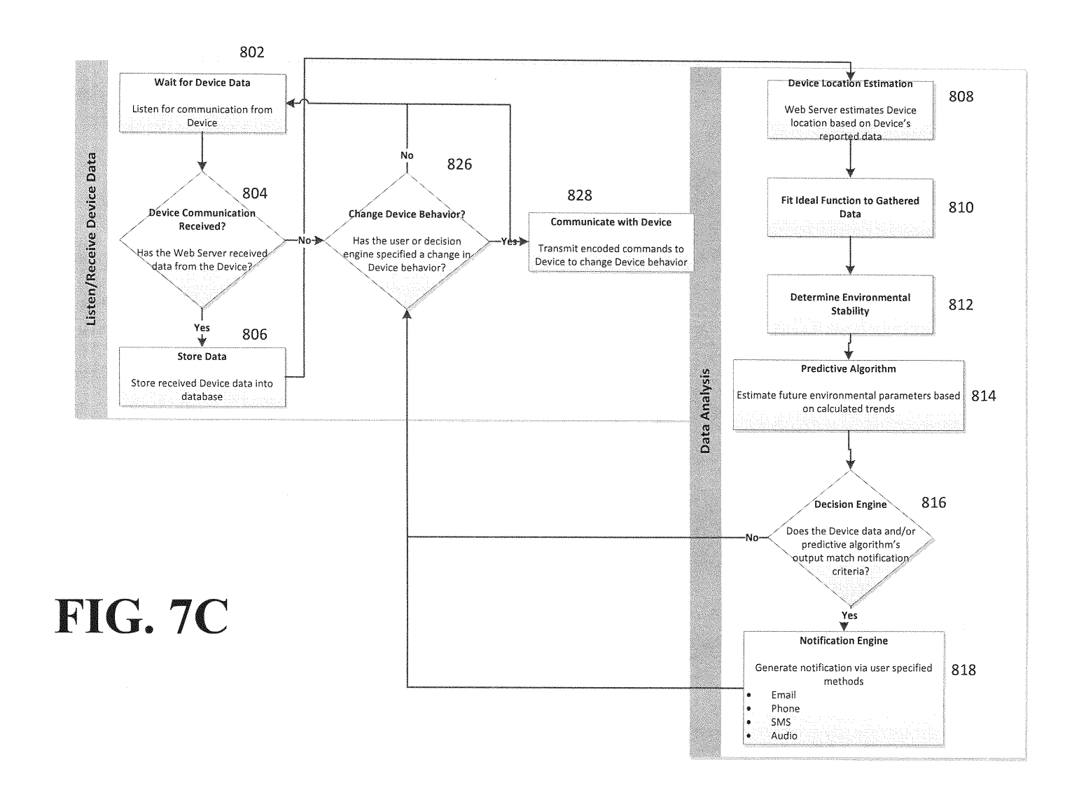

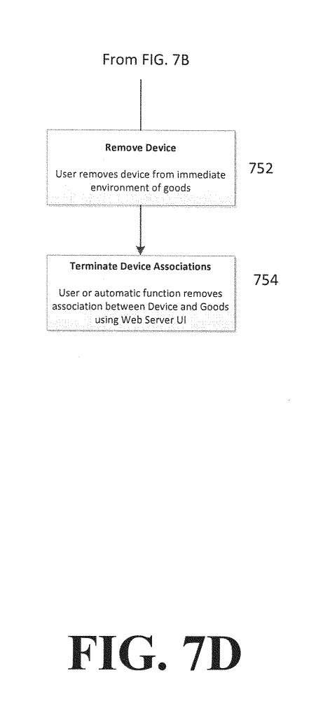

FIG. 7A-7D show an exemplary method of using a module (e.g., device/sensor) to track one or more environmental parameters associated with products in transport.

The exemplary method includes selecting (at 702) one or more modules appropriate for a particular application and then physically attaching (at 704) the selected modules to the device.

A determination is made whether additional firmware/programming updates for the device are necessary for operation and, if so, new firmware, for example, is uploaded (at 708) to the device via a system programming header.

If a SIM card has been selected (at 710), a user of the device inserts the SIM card (at 712) into the device, or otherwise associates a cellular telephone number with the device. The user (at 714) then enters the device's associated cellular telephone number and details of the goods placed in the immediate environment of the device into a user interface interfacing with the web server. Means besides a user interface could be used to perform this association.

The web server (e.g., at server 108) stores the association and related information in a database (e.g., in memory 306). In this instance, the cellular telephone number might be used as a unique identifying code for the device, but some other unique identifying code could be used.

The user then specifies/selects (at 716) several notification parameters for the shipment, as well as notification methods. These specifications may be used to configure a notification engine (that may be implemented, for example, by virtue of the processor 302 executing the software 308). For example, the user may wish to be notified via email if the temperature of the environment surrounding the goods falls below 0 degrees Celsius. the user may elect to be notified in the event of a variety of environmental or device conditions, including any condition which can be measured by the device or derived from measurements performed by the device (such as location), using any of a variety of notification methods, including but not limited to email, phone, SMS message, or audible alert. The user may also specify notification parameters for stakeholders other than himself, or those stakeholders may add notification parameters independently using the same or another web server and user interface or other method.

The user also performs remote programming of the device (at 718) through a communications network.

Upon associating a cellular telephone number with the device, placing the device in the immediate environment of goods intended for transport, recording the association between the device and the goods using the user interface and specifying notification parameters, the user (at 720) places the device in an immediate environment of goods intended for transport and, then, releases (at 722) the goods for transport. The transportation carrier may be the device user, and a different stakeholder may use the device to monitor a shipment.

As the goods are transported, the device periodically performs a data capture routine. The period at which this routine is performed may be configured permanently in the firmware stored on the device's microprocessor component, or may be changed dynamically based on the device's state, a condition of the environment immediately surrounding the device, or other factors.

To perform the data capture routine, the device first wakes (at 724) from a power-conserving sleep state. Waking may consist of enabling components which were previously disabled, activating electrical connections which were previously deactivated, or otherwise transitioning the device from a state of idleness to state of readiness for use. The full transition to a state of readiness for use need not occur before the actions described below are taken, and not all components must be in a state of readiness at all points of the data capture routine.

Upon waking, the device's microprocessor component uses the device's sensor components to collect data (at 726) on the immediate environment of the device, and thus the environment of the associated goods in transit. The microprocessor component may also gather data on the state of the device, such as battery charge state, using components other than the sensor components.

The device encodes data (at 728) into a network compatible format and stores data (at 730) in the device's memory queue.

The microprocessor component then uses the cellular communication component to check (at 732) if a communications network (e.g., a cellular network) is available. If (at 732) it is determined that no network is available, then the microprocessor component records the current time, encodes all environmental, device state and time data into a format appropriate for transmission, stores the data in a persistent memory queue, and reenters (at 734) a sleep state, until (at 736) reawakening. In some implementations, the device may store data for later transmission even if a cellular network is available, such as if the device is in a location where cellular transmission is inappropriate.

If it is determined (at 732) that a cellular network is available and the device is not configured to disallow transmission, the device's microprocessor component uses the cellular communication component to receive (at 738) any commands which may have been sent from the web server via an external gateway or other method, and processes these commands. Commands may include commands to change parameters of the device's configuration, such as to change the period at which the device transmits data, to prevent the device from transmitting data for a specified period of time, or to enable or disable sensing components on the device. Other commands are possible as well.

The device then considers (at 740) if the web server has initiated a local notification. If not, a local notification is initiated.

Once all incoming commands are executed, the device's microprocessor component uses the cellular communication component to read identifying information and signal strength information from cellular nodes to which the device is connected, or from nodes which are geographically nearby the nodes to which the device is connected. These nodes may consist of cellular towers or other transmission equipment within an existing cellular network. The identifying information gathered may include cell ID and LAC. Other cellular node identifying information may be gathered as well, or that other parameters of the cellular network may be gathered by the device.

Upon gathering cellular data, the device's microprocessor component encodes all environmental, device state, cellular and other data gathered in the previous steps into a format appropriate for transmission. As used here and above, encoding data into a format appropriate for transmission consists of formatting the data in a structured way such that all data needing transmission can be represented using 160 or fewer ASCII characters, but such that the data can be reliably read and consistently parsed into its constituent measurements after transmission. This formatting can be achieved using a structured data representation schema, as well as a compression protocol to reduce the necessary size of the transmitted data. The device achieves this formatting using Java script Object Notation and a protocol for assigning single ASCII characters to represent numerical ranges, but one with reasonable skill in the field will recognize that any formatting schema and compression system which reduces the size of the transmitted data to 160 or fewer ASCII characters while preserving the ability to consistently read and parse the data into its constituent measurements could be used. One with reasonable skill in the field will also recognize that data which exceeds 160 ASCII characters after encoding could be divided into several smaller data sets, which could be associated together such that each sub data set and the data needed to mark it as a member of the master set was 160 ASCII characters or fewer. Further, one will recognize that a maximum data length of greater or less than 160 ASCII characters could also be used. Multiple data sets which, combined together, are less than 160 ASCII characters in length may be combined into a single data set.

After encoding, the device's microprocessor component appends the transmission-ready data to a queue stored in memory. Following storage, the microprocessor component retrieves one or more stored data units from the queue, and uses the cellular communication component to transmit the data units (at 744) through the associated cellular network to the gateway using a 160 ASCII character Short Message Service message. The gateway to which the message is directed is identified using a telephone number which is either stored permanently in the device's firmware, or can be set dynamically using an incoming device command or another method. Any other cellular transmission protocol could also be used to transmit the data unit, or that the Short Message Service message could be of a length other than 160 ASCII characters. Another method could be used to identify the target gateway, or that multiple gateways could be chosen by the device. If the transmission is successful, the microprocessor component deletes the data units from the queue (at 746), and attempts to retrieve additional units. The device continues this procedure until the queue is empty (748), or transmission fails. If either of these circumstances occurs, the device reenters a sleep state.

Referring now to FIG. 7C, the gateway of the web server is adapted to listen (at 802) for communication from the device. Upon receiving an encoded message (at 804) transmitted from the device via a cellular network or other method, the gateway parses the encoded message and sends the discrete data contained in the message to the web server. A message may be considered any data unit or units transmitted from the device, and a gateway may be any system which can receive a message and relay the data contained therein. A gateway could be a hardware SMS gateway, software web service, or other system or may be a component of the web server and not a discrete unit. The gateway may be integral with the server 108. In addition to sending data contained in the device's transmitted message to the web server, the gateway sends data derived from the device's transmission to the web server. These derived data include the cellular telephone number associated with the device and the time the message was received. The gateway may derive other information from the device's transmission, or that a method other than a cellular phone number may be used to associate the transmission with a particular device.

Upon receiving data from the gateway, the web server (at 806) stores the data in the database, associating the data with the proper shipment by matching the cellular telephone number derived by the gateway with the cellular telephone number provided by the user when the shipment was initially created. If a unique identifying code other than a cellular telephone number is used to associate the device with a shipment, and that if the same unique identifying code is included in each message transmitted by the device, the web server may match the data in the message with the proper shipment using this unique identifying code in the place of a cellular telephone number.

The web server then references the cellular node identifying information and signal strength information derived from the device's cellular communication component and contained in the message against a database of cellular network nodes in order to derive the location (at 808) of the device at the time of transmission. Any existing database of cellular network node locations, as well as any existing cellular network node triangulation algorithm could be used to derive the device's location from the cellular network node identifying information and signal strength information. In general, the location determination method can be performed using cellular network data which has been gathered by the device and generally does not require any data processing relevant to determining the device's location be performed on the device at the time of transmission in order to derive the device's location at a later time.

The server then fits an ideal function to the gathered data (at 810), determines environmental stability (at 812) and applies (at 814) a predictive algorithm, such as those described herein, to estimate one or more future environmental parameters based on calculated trends.

The web server then uses the notification engine (e.g., in the server 108) to determine (at 816) if any of the data received results in a condition which the user has identified as a trigger for notifications. If so, the notification engine (at 818) provides one or more notifications to the user based on parameters specified by the user. For example, if the data received by the web server included a temperature measurement of −1 degrees Celsius and the user had requested an email notification if the temperature of the goods in transit fell below 0 degrees Celsius, the notification engine would dispatch an email notification to the user. The notification engine could also send notifications based on statistical trends indicating that shipments conditions would likely cross a threshold at some time in the future. The notification engine may send notifications in the event that a condition has not been met. The user may also access the User Interface at any time to view data associated with the shipment.

On receiving data, the web server also executes a device configuration routine. Based on environmental data, device state data, and other derived data from the last data unit transmitted, the web server uses a decision engine (implemented, e.g., as part of the server 108) to determine (at 820) whether any changes should be made to the device's configuration. For example, if the last data unit transmitted indicated a low battery state, the decision engine might determine that the frequency with which the device transmits data should be extended, so that the device spends more time in its power-conserving sleep state. In another scenario, the decision engine might determine that the location of the device's last transmission suggests that the device is approaching a place, such as an airport, where cellular transmission is inappropriate. The decision engine would then determine that the device should cease further cellular transmissions for a specific length of time. Any combination of device or environmental state readings could result in any number of desired device configuration changes. Should the decision engine determine that a device configuration change is necessary, the web server transmits an instruction (at 828) to the device using a gateway or another method. One with reasonable skill in the field will recognize that the decision engine may be utilized at other times, such as when the user initially creates a shipment, or if the user manually specifies a desired change to the device's configuration while the shipment is in progress.

Once the shipment is complete and the goods in transit have reached their final destination, the device is removed (at 752) from the immediate environment of the goods, and the association between the device and the goods is terminated (at 754). This termination of association may occur through automatic means, such as by the goods reaching a particular geographical location, or may be initiated manually using a User Interface. Once a shipment is complete, the database continues to store data associated with the shipment, but the web server no longer adds new data to the shipment. After a shipment is complete, the receiver of the goods may return the device to the initial user, or may associate it with a new shipment using the User Interface and repeat the shipment process again, or may discard it.

If the device is so equipped, the user may also refresh its battery by connected the device's charging power input jack to an appropriate power source. In an alternate scenario, the device may have received power from an external source throughout the shipment, and may have no further power requirements.

In another implementation, a device is provided for monitoring the conditions of items in a container, box, chamber, room, building or any other physical space whose location does not change during the duration of the monitoring, and a method is provided for relaying information about the items' condition to a central server for monitoring, analytics and stakeholder notification. Such a container, box, chamber, room, building or other physical space could include the chamber of a fixed location cold storage refrigeration unit, a climate controlled warehouse, the chamber of a heated incubator, or any other space with a fixed physical location. This implementation does not generally involve monitoring shipments, as the physical location of the monitored environment does not change during the monitoring. In this implementation, the above described device may be used for perform the monitoring. The device may also be modified to transmit gathered data using a transmission technology other than cellular transmission, using a transmission method other than SMS messages, using a method other than a gateway to receive transmitted data, or using a method other than a cellular telephone number to uniquely identify each device. For example, the device may use Wi-Fi, Bluetooth or other short range radio technology to transmit data, a TCP/IP data connection as the method of transmission, a web service running on a web server as the method for receiving data, and a unique number pre-assigned to each device as the means to identify transmissions from individual devices. Additionally, this implementation may involve the use of an intermediate device, such as a wireless router, cellular hot spot, or other intermediary to receive transmissions from the primary device and relay them on to a server. Other modifications could be made to the device previously described, or a different device could be used to monitor the conditions of items in the container, box, chamber, room, building or other physical space whose location does not change.

Once the device has transmitted data to a server, the same system and methods described above may be used to store and analyze the data, or another system and or method may be used. In a further implementation, a device (e.g., a sensor) is integrated into a refrigerator, freezer, incubator or other temperature controlled storage device which monitors the environmental conditions of items within the chamber of the storage device, and a method is used for relaying information about the items' condition to a central server for monitoring, analytics and stakeholder notification. In this implementation, the monitoring device and the components of the temperature controlled storage device may not be separable. For example, the device could comprise one or more thermocouples within the chamber of a refrigeration unit, connected to a Wi-Fi, Ethernet, short range radio or other transmission unit capable of transmitting temperature data from the thermocouples to a server, either by way of an intermediary router or other device, or directly.

A temperature sensor other than a thermocouple could be used, environmental parameters other than temperature could be monitored, or a storage unit other than a refrigerator could be monitored. Once the device has transmitted data to a server, the same system and methods described previously may be used to store and analyze the data, or another system and or method may be used.

In a further implementation, a modular device is provided for taking measurements of environmental parameters and a process is used for relaying those measurements to a remote database, or otherwise taking some action based on the measurements. The device may consist of one or more printed circuit boards which can be populated with a set of modular components, including a sensing module for monitoring environmental and device state conditions, a processing module for reading data from the Sensing module and encoding it for transmission, a communication module for transmitting relevant data to a remote database over a variety of network technologies or communicating the data in another way, and a power module which provides electrical power to the other modules. Together, these modules provide components for environmental sensing, and each module may be swapped out independently of the others in order to customize the device for a particular sensing application.

The sensing module can measure a variety of factors related to the environment immediately surrounding the device, including temperature, humidity, barometric pressure, light intensity, ionizing radiation intensity, concentration of gases including carbon monoxide, carbon dioxide, nitrous oxide, sulfur dioxide, and liquid propane gas, electrical conditions including voltage or current of a connected or nearby electrical wire, and image or video of the device's surroundings. Additionally, the sensing module can measure a variety of device states, including battery level, device acceleration, device vibration, device orientation with respect to the horizon or to the Earth's magnetic field, and device location. Other elements of the device's state and immediate environment may be measured by the sensing module as well. The sensing module consists of one or more sensors which allow for environmental or device state sensing, such as a temperature and humidity sensor. In this description, the term sensor may refer generally to electrical components or integrated circuits which provide measurements of some aspect of the device's state or immediate environment. These sensors can be attached the device's printed circuit board using SMT or through-hole soldering techniques. Other soldering techniques or connection methods could be used as well.

Each sensor in the sensing module may provide data using a different intra-device electrical communication method, and may require a different reading method. In order to accommodate a variety of different sensor components in the Sensing module, the device employs a processing module which is preconfigured to communicate with attached Sensing modules using a variety of intra-device communications standards. The processing component can consist of an ATMEGA 328P microprocessor operating at a frequency of 8 mhz. The microcontroller is populated with firmware allowing reading of data from sensor components using intra-device standards including serial/UART, Dallas 1 wire, and I2C. Additionally, the microprocessor includes an analog to digital converter circuit which allows it to read data from sensing modules which utilize analog sensors. Other intra-device electrical communication standards could be employed as well. The processing module's firmware contains additional pre-configured software functions, as detailed below. In this context, elements of the processing module which are pre-configured are either chosen from a set of available functions stored externally to the processing module, compiled, and uploaded to the processing module's microprocessor during device manufacture, or are included by default in the microprocessor's firmware without the need for any selection during manufacture. The device's firmware is written using an object oriented programming language for easy of modification, before being compiled to machine code for the processing module's microprocessor. Other language types could be used as well.

Each intra-device communication standard which the processing module may employ is assigned to a set of electrical pins on the processing module's microcontroller. These pins are electrically connected to the sensors in the sensing module which use the corresponding intra-device communication standard. If the sensing module configuration chosen for a particular application does not use a particular intra-device communication technology, the microcontroller pins corresponding to that technology are not connected. If the sensing module configuration chosen for a particular application requires the use of more than one sensor employing the same intra-device communication standard, multiplexing systems may be used, or multiple microcontrollers may be used in the processing module. Other than the assignment of electrical pins to particular intra-device communication standards could be used to connect the processing and sensing modules. Because the processing module is preconfigured to connect to a variety of sensor types using existing intra-device communications standards, sensing modules with different sensors may be substituted in order to customize the device for a particular application without requiring the use of a different processing module.

The processing module also includes external EEPROM memory for storing data on the device. One with ordinary skill in the field will recognize that another microprocessor could be used instead of the ATMEGA 328P, or that the microprocessor could operate at a frequency other than 8 mhz. An external storage technology other than EEPROM could be utilized, and/or data storage could be achieved through other means.

The communication module can allow the device to transmit data obtained from the sensing module to a remote database or web server, or take other communicative actions based on the data. The module consists of a transceiver which is electrically connected to the device. In this description, the term transceiver means any electrical component or integrated circuit which allows data to be transmitted or received over a wired or wireless network. The communication module's transceiver may employ Wi-Fi, GSM, Zigbee, Bluetooth, Ethernet or ANT transmission technologies. The communication module may use other data transmission methods as well. Additionally, the communication module's transceiver need not transmit or data to a database or web server, and may instead transmit data using another method, such as an audible alert. The communication module's transceiver communicates electrically with the Processing module using UART, although another intra-device communication standard could be employed. Because the communication module's transceiver is distinct from the device's processing and sensing modules, communication modules utilizing different communication technologies may be substituted in order to customize the device for a particular application without requiring the use of a different sensing or processing module.

The power module can consist of a lithium polymer battery, lithium polymer charging circuit, charging power input jack, power filtering system, and voltage regulator. The lithium polymer battery provides a raw voltage of 3.7 v with a capacity of 2000 milliamp hours, and includes a circuit for detecting over voltage and over current conditions. The lithium polymer charging circuit allows the battery to be charged using an input of between 3.7 and 12 volts. The charging power input jack allows charging power to be supplied from a variety of sources, including but not limited to an external power supply, solar panel, or vehicle power system. The power filtering system consists of a network of capacitors which are used to filter any undesired electrical noise present in power provided to the device either through the charging power input jack or from the lithium polymer battery. The voltage regulator is used to regulate the voltage of power supplied to the device from the lithium polymer battery or charging power input jack to an appropriate level for the other modules of the device. The voltage regulator may supply a different voltage or maximum current to each component on the board, or may provide multiple voltages for various subcomponents, including multiple sensors requiring various voltages. A battery technology other than lithium polymer could be used, that the battery could operate at a voltage other than 3.7 volts, that the battery could provide a capacity other than 2000 milliamp hours, and that the battery and charging circuit could be eliminated entirely.

This device's printed circuit board is generally designed to spatially isolate temperature-sensitive sensor components from heat-generating components of the device, although another isolation technique could be used. Other sensors whose readings could be affected by elements of the device could be isolated from those elements using similar techniques. An In System Programming header is provided for uploading compiled code to the processing module's microprocessor, although another uploading method could be used, or the ability to upload code to the processing module's microprocessor following manufacture of the device could be eliminated.

In general, the device is intended to be placed in an environment whose parameters are to be sensed, such that the device's immediate environment corresponds to the environment to be sensed. The device's processing module reads environmental and device state data from the Sensing module at specified intervals. The processing module encodes these data for transmission and transmits them to a remote web server using the communications module, or takes some other communicative action. The web server stores the data in a database, and makes it available using one or more user interfaces. The web server may also perform statistical analyses of the data, and utilize a notification engine to inform stakeholders of notable trends in the data. The web server may utilize a decision engine to transmit desired changes in the device's configuration back to the device. A gateway may be employed to receive transmissions from the device and retransmit them to the web server, or the web server may receive transmissions from the device directly. Data from the device may be transmitted to a system other than a web server, and/or remote transmission may not occur at all, and/or the device may communicate data locally using methods such as audible alerts.

If the device will be used for remote monitoring of sensed data, a user of the device begins monitoring an environment by entering a unique identifying number associated with the device into a user interface connected to the web server. Other methods may be used to initiate sensing if the device will be communicating data locally. The web server stores this association in the database. If the device is utilizing a communication module with a cellular transmitter, this unique identifying number may be the cellular phone number assigned to the device, but another unique identifying number could also be used. The user may then specify several notification parameters, as well as notification methods. These specifications are used to configure the notification engine. For example, the user may wish to be notified via email if the some parameter of the environment being sensed exceeds some threshold. The user may elect to be notified in the event of a variety of environmental or device conditions, including any condition which can be measured by the device or derived from measurements performed by the device, using any of a variety of notification methods, including but not limited to email, phone, SMS message, or audible alert. The user may also specify notification parameters for stakeholders other than himself, or those stakeholders may add notification parameters independently using the same or another web server and graphical user interface.

Upon associating a unique identifying number with the device, recording the association between the device and the environment being sensed using the graphical user interface and specifying notification parameters, the user places the device in the environment to be sensed. The device then performs a measurement and transmission routine. The period at which this routine is performed may be configured permanently in the firmware stored on the device's microprocessor unit, or may be changed dynamically based on the device's state, a condition of the environment immediately surrounding the device, or other factors.

To perform the routine, the device first wakes from a power-conserving sleep state. Waking may consist of enabling components which were previously disabled, activating electrical connections which were previously deactivated, or otherwise transitioning the device from a state of idleness to state of readiness for use. Upon waking, the device's processing module uses the device's Sensing module to measure data on the immediate environment of the device, and thus the environment to be sensed. The processing module accomplishes this by determining which sensor types are electrically connected to it in the sensing module, finding the correct electrical pins corresponding to the intra-device communication standard used by those sensor types, determining the correct reading method for each sensor type, and poling each sensor for data. The processing module may also gather data on the state of the device, such as battery charge state, using components other than the Sensing module's sensors.

The processing module may then determine which transmitter type is electrically connected to it in the transmission module, as well as the correct transmission encoding type for the transmitter in the device's transmission module. The processing module then attaches a timestamp to the raw data obtained from the sensing modules sensors, and writes the data to a persistent memory queue. Next, the processing module checks whether transmission is currently possible. If transmission is possible and the device is not configured to disallow transmission, the device's processing module uses the communication module to receive any commands which may have been sent from the web server, and processes these commands. Commands may include commands to change parameters of the device's configuration, such as to change the period at which the device transmits data, to prevent the device from transmitting data for a specified period of time, or to enable or disable sensors in the device's sensing module. Other commands are possible as well.

Once all incoming commands are executed, the device's processing module retrieves one stored data unit from the persistent memory queue, encodes all environmental, device state, other data gathered in the unit into the format appropriate for transmission using the transmission module's transmitter. As used here, encoding data into a format appropriate for transmission consists of formatting the data in a structured way such that all data needing transmission can be reliably read and consistently parsed into its constituent measurements after transmission. This formatting can be achieved using a structured data representation schema, as well as a compression protocol to reduce the necessary size of the transmitted data. The device achieves this formatting using Java script Object Notation but any formatting schema and compression method which preserves the ability to consistently read and parse the data into its constituent measurements after transmission could be used.

After encoding, the device's processing component transmits the encoded data unit using the transmission module's transmitter. If the transmission is successful, the microprocessor component deletes the data unit from the queue, and attempts to retrieve another unit. The device continues this procedure until the queue is empty, or transmission fails. If either of these circumstances occurs, the device reenters a sleep state.

An encoded message from the device may be received either by the web server, or by an intermediate gateway device. A gateway could be a hardware SMS gateway, software web service, or other system or may be a component of the web server and not a discrete unit. In addition to sending data contained in the device's transmitted message to the web server, the gateway may send data derived from the device's transmission to the web server. These derived data may include the cellular telephone number associated with the device and the time the message was received, should the device include a cellular transmitter. The gateway may derive other information from the device's transmission, or may use a method other than a cellular phone number to associate the transmission with a particular device.

Upon receiving data, the web server stores these data in the database. The data are associated with the proper device by matching the cellular telephone number derived by the gateway with the cellular telephone number provided by the user when the device was associated with an environment, or by using a different unique identifying number transmitted by the device.

Once new data has been received and associated with a device and its associated environment, the web server uses the notification engine to determine if any of the data received results in a condition which the user has identified as a trigger for notifications. The notification engine then provides notifications based on the parameters specified by the user. For example, if the data received by the web server included a temperature measurement of −1 degrees Celsius and the user had requested an email notification if the temperature of the environment being sensed fell below 0 degrees Celsius, the notification engine would dispatch an email notification to the user. One with reasonable skill in the field will recognize that the notification engine could also send notifications based on statistical trends indicating that environmental conditions would likely cross a threshold at some time in the future. One will further recognize that the notification engine may send notifications in the event that a condition has not been met. The user may also access the Graphical User Interface at any time to view data associated with the shipment.

On receiving data, the web server also executes a device configuration routine. Based on environmental data, device state data, and other derived data from the last transmission, the web server uses a decision engine to determine whether any changes should be made to the device's configuration. For example, if the last transmission indicated a low battery state, the decision engine might determine that the frequency with which the device transmits data should be extended, so that the device spends more time in its power-conserving sleep state. One with reasonable skill in the field will recognize that any combination of device or environmental state readings could result in any number of desired device configuration changes. Should the decision engine determine that a device configuration change is necessary, the web server transmits an instruction to the device. A gateway may be used to achieve this transmission. The decision engine may be utilized at other times, such as when the user initially associates a device with an environment to be sensed, or if the user manually specifies a desired change to the device's configuration while sensing is in progress.

While the sensing and transmission routines are occurring the device's power module provides electrical power to the sensing, processing and transmission modules. The power module may provide different voltages or currents to each module, or to components of each module, such as sensors employed by the sensing module. Voltages may be selected using either variable voltage regulation specified in software, or using hardware selection methods including the use of multiple voltage regulators, or the use of a single voltage regulator whose output is specified using a capacitor/resistor network. Other voltage selection methods are possible.

Because the device always uses the same processing module, the 3.3 volts required by the processing module is always provided by the power module, regardless of the power requirements of other modules. If a different microprocessor were used in the processing module, different voltage might be required from the power module. Raw electrical power may be provided to the power module through the module's charging power input jack. Any power source which provides up to 12 volts may be used, and sources may include regulated wall power, vehicle power, solar power, power from an external battery, or wind power. Other power sources or input voltages may be utilized as well.

Because the device's processing module is pre-configured to electrically connect to a variety of sensing module sensors using a variety of intra-device communication standards, and because the processing module selects the correct sensor reading method for the connected sensors from a set of pre-configured options, a variety of different sensing modules may be used interchangeably with the device. Additionally, because the device's processing module is pre-configured to electrically connect to a variety of communication module transmitters, and because the processing module selects the correct transmission encoding method for the attached communication module from a set of pre-configured options, a variety of transmission modules may be used interchangeably with the device. Finally, because the device's power module may be configured to accept power input from a variety of sources and provide power output in a variety of voltages suitable for any combination of sensing, processing and transmission modules, the device may operate with any combination of these modules installed.

Because of this modular configuration, customizing the device to a particular application may be accomplished by choosing the proper combination of sensing and transmission modules for the application and providing an appropriate power source and Power module configuration for the application. Thus, the device may be easily configured for use in a variety of applications. For example, a user who wishes to monitor the temperature of refrigeration unit in a warehouse may customize the device using a Sensing module with a temperature sensor, a communication module with a Wi-Fi transmitter, and a wall-power external power source. Substituting a communication module with a GSM cellular transmitter would allow the same device to be used for monitoring temperature data at a remote storage. Replacing the wall-power external power source with a solar panel while retaining the GSM Communication module would allow the device to be used for monitoring the temperature of a remote outdoor environment, such as a farmer's field or a city street. Replacing the temperature sensing module with a sensing module which includes a sensor for ionizing radiation would allow the same device to detect radiological threats in an outdoor environment and send alerts to stakeholders. Any combination of sensing modules, transmission modules, and external power sources could be used to customize the device for any particular sensing application.

In at least some of the above-described implementations, it is assumed that the condition of the items to be monitored is dependent on the conditions of the environment immediately surrounding the items. By monitoring the environment surrounding the items, the condition of the items may be inferred. However, the above-described devices and systems may be used to monitor an environment without making assumptions about the conditions of items within that environment, or may be used to monitor an environment which does not contain any items. Additionally, some additional methods may be used to determine the effect of the environment surrounding the items to be measured on the condition of the items. For example, a formula may be applied to determine how greatly a change in the parameters of the environment immediately surrounding the items will affect the condition of the items.

### ADDITIONAL ASPECTS OF VARIOUS EMBODIMENTS

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-based method comprising:
collecting a sequence of measurements related to a controllable environmental parameter in a monitored space over time;
deriving a master curve based on the sequence of collected measurements to characterize normal periodic variations in the controllable environmental parameter over time;
collecting one or more subsequent measurements that represent the controllable environmental parameter of the monitored space; and
evaluating a likelihood that the controllable environmental parameter will, at some future point in time, exceed an acceptable level by comparing a curve associated with one or more of the subsequent measurements to the master curve.

2. The computer-based method of claim 1, further comprising alerting one or more system operators if the evaluation reveals a likelihood that the controllable environmental parameter will, at some future point in time, exceed an acceptable level,
wherein the alerting is in advance of the controllable environmental parameter exceeding the acceptable level.

3. The computer-based method of claim 1, further comprising:
estimating the future point in time that the controllable environmental parameter will exceed the acceptable level.

4. The computer-based method of claim 3, further comprising:
presenting to one or more system operators an indication of the estimated future point in time that the controllable environmental parameter will exceed the acceptable level.

5. The computer-based method of claim 1, wherein deriving the master curve to characterize the normal periodic variations in the controllable environmental parameter over time comprises:
dividing the sequence of collected measurements into groups of sequentially collected measurements;
fitting a group curve to each respective group, wherein each group curve is defined by a standard-form variable equation having coefficients that can vary from group curve to group curve;
calculating a statistical measure of central tendency for each respective coefficient in the standard-form variable equation, based on corresponding coefficients in the standard-form equations that define at least two or more of the group curves; and
creating the master curve by applying the corresponding calculated statistical measure of central tendency for each respective coefficient in the standard-form variable equation.

6. The computer-based system of claim 5, wherein the standard-form variable equation is a quadratic equation having a form of f(x)=a0x2+a1x+a2 or a cubic equation having a form f(x)=a0x3+a1x2+a2x+a3,
wherein a0, a1, a2 and a3 are the coefficients of the standard-form variable equation.

7. The computer-based method of claim 1, wherein comparing the curve associated with the one or more subsequent measurements with the master curve comprises:
fitting a subsequent measurement curve to a first one of the subsequent measurements based on the first subsequent measurement and one or more other measurements collected sequentially relative to the first subsequent measurement;
quantifying a degree to which the subsequent measurement curve deviates from the master curve.

8. The computer-based method of claim 7, wherein quantifying the degree to which the subsequent measurement curve deviates from the master curve comprises:
calculating one or more z-scores associated with one or more coefficients in the standard-form equation that defines the subsequent measurement curve and one or more respective corresponding coefficients in the standard-form equation that defines the master curve.

9. The computer-based method of claim 8, wherein evaluating the likelihood that the controllable environmental parameter will, at some future point in time, exceed an acceptable level comprises:
determining whether one or more of the calculated z-scores exceed a corresponding threshold.

10. The computer-based method of claim 9, wherein determining whether one or more of the calculated z-scores exceed the corresponding threshold comprises:
comparing the one or more z-scores to corresponding standard deviations associated with the associated coefficients.

11. The computer-based method of claim 1, further comprising:
deriving, based on the master curve, one or more physical or operational parameters of the monitored space or a control system configured to control the environmental parameter in the monitored space.

12. The computer-based method of claim 11, wherein the physical or operational parameters include:
one or more physical parameters of the monitored space relevant to facilitating control over the environmental parameter in the monitored space; or
one or more operational parameters associated with the control system.

13. The computer-based method of claim 11, further comprising:
presenting one or more recommendations to a system operator based on one or more of the derived parameters,
wherein the one or more recommendations relate to a physical parameter of the monitored space or an operational parameter associated with the control system.

14. The computer-based method of claim 1, wherein the environmental parameter is selected from the group consisting of: temperature, humidity, barometric pressure, moisture, visible or ultraviolet light intensity, radiation, particulate contamination, air quality, relative position, acceleration and shock load.

15. A computer system comprising:
a sensor arranged and configured to measure a controllable environmental parameter; and
one or more processors coupled to the sensor via a communications network, wherein the one or more processors are configured to:
receive a sequence of measurements related to the controllable environmental parameter in a monitored space over time from the sensor;
derive a master curve based on the sequence of collected measurements to characterize normal periodic variations in the controllable environmental parameter over time;
collect one or more subsequent measurements that represent the controllable environmental parameter of the monitored space; and
evaluate a likelihood that the controllable environmental parameter will, at some future point in time, exceed an acceptable level by comparing a curve associated with one or more of the subsequent measurements to the master curve.

16. The computer system of claim 15, further comprising:
a user-interface coupled to the one or more processors via the communications network, wherein the one or more processors are further configured to:
alert one or more system operators if the evaluation reveals a likelihood that the controllable environmental parameter will, at some future point in time, exceed an acceptable level,
wherein the alert comprises an indication made available to one of the system operators from the user-interface in advance of the controllable environmental parameter actually exceeding the acceptable level.

17. The computer system of claim 15, wherein the one or more processors are further configured to:
estimate the future point in time that the controllable environmental parameter will exceed the acceptable level, and
make available to the one of the system operators from the user-interface an indication of the estimated future point in time that the controllable environmental parameter will exceed the acceptable level.

18. The computer system of claim 15, wherein deriving the master curve to characterize the normal periodic variations in the controllable environmental parameter over time comprises:
dividing the sequence of collected measurements into groups of sequentially collected measurements;
fitting a group curve to each respective group, wherein each group curve is defined by a standard-form variable equation having coefficients that can vary from group curve to group curve;
calculating a statistical measure of central tendency for each respective coefficient in the standard-form variable equation, based on corresponding coefficients in the standard-form equations that define at least two or more of the group curves; and
creating the master curve by applying the corresponding calculated statistical measure of central tendency for each respective coefficient in the standard-form variable equation.

19. The computer system of claim 15, wherein comparing the curve associated with the one or more subsequent measurements with the master curve comprises:
fitting a subsequent measurement curve to a first one of the subsequent measurements based on the first subsequent measurement and one or more other measurements collected sequentially relative to the first subsequent measurement;
quantifying a degree to which the subsequent measurement curve deviates from the master curve,
wherein quantifying the degree to which the subsequent measurement curve deviates from the master curve comprises calculating one or more z-scores associated with one or more coefficients in the standard-form equation that defines the subsequent measurement curve and one or more respective corresponding coefficients in the standard-form equation that defines the master curve, and
wherein evaluating the likelihood that the controllable environmental parameter will, at some future point in time, exceed an acceptable level comprises determining whether one or more of the calculated z-scores exceed a corresponding threshold.

20. The computer system of claim 15, wherein the one or more processors are further configured to:
derive, based on the master curve, one or more physical or operational parameters of the monitored space or a control system configured to control the environmental parameter in the monitored space,
wherein the physical or operational parameters include:
one or more physical parameters of the monitored space relevant to facilitating control over the environmental parameter in the monitored space; or
one or more operational parameters associated with the control system.

21. The computer system of claim 20, wherein the one or more processors are further configured to:
make accessible from a user-interface device coupled to the one or more processors, one or more recommendations to a system operator based on one or more of the derived parameters,
wherein the one or more recommendations relate to a physical parameter of the monitored space or an operational parameter associated with the control system.

22. The computer system of claim 15, wherein the environmental parameter is selected from the group consisting of: temperature, humidity, barometric pressure, moisture, visible or ultraviolet light intensity, radiation, particulate contamination, air quality, relative position, acceleration and shock load.
